(19) United States
(12) Patent Application Publication
(10) Pub. No.: US 2026/0023951 A1
(43) Pub. Date: Jan. 22, 2026

(54) METHODS AND SYSTEMS FOR CUSTOMIZED QUERY RESPONSES USING ARTIFICIAL INTELLIGENCE

(71) Applicant: Google LLC, Mountain View, CA (US)

(72) Inventors: John James Lunney, Zürich (CH); Johannes Elias Start, Walchensee (DE)

(21) Appl. No.: 18/780,319

(22) Filed: Jul. 22, 2024

(51) Int. Cl. G06N 3/045; G06V 30/19

(52) U.S. Cl. CPC G06N 3/045; G06V 30/19147

(57) ABSTRACT

Methods and systems for customized query responses using artificial intelligence are provided. A request is received from a client device of a user associated with a client account to perform an operation associated with an artificial intelligence (AI) model. An adapter model associated with the client account is identified. The adapter model is trained to modify parameters of the AI model based on electronic documents having a preferred style or a preferred format of the client account. A prompt including the request to perform the operation as an input to the adapter model. An output of the adapter model is used by the AI model. An output of the AI model is obtained, the output having at least one of the preferred style or the preferred format of the client account. A response to the request is provided using the obtained output of the AI model.

### TECHNICAL FIELD

Aspects and implementations of the present disclosure relate to customized query responses using artificial intelligence.

### BACKGROUND

The development and deployment of artificial intelligence (e.g., large language models (LLMs) has revolutionized various industries by enabling highly sophisticated natural language processing capabilities. Artificial intelligence (AI) models are trained on vast datasets and possess the ability to generate human-like text and provide informative responses to user queries. User experience, satisfaction, and utility of applications leveraging AI models can be impacted not only by the relevancy of responses obtained using such AI models, but also the style and/or format of such responses.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method that includes receiving, from a client device of a user associated with a client account, a request to perform an operation associated with an artificial intelligence (AI) model. The method further includes identifying an adapter model associated with the client account. The adapter model is trained to modify one or more parameters of the AI model based on one or more electronic documents associated with the client account, the one or more electronic documents having a preferred style or a preferred format of the client account. The method further includes providing a prompt including the request to perform the operation as an input to the adapter model. An output of the adapter model is used by the AI model. The method further includes obtaining an output of the AI model. The obtained output has at least one of the preferred style or the preferred format of the client account. The method further includes providing a response to the request that is performed using the obtained output of the AI model.

In some embodiments, the method further includes prior to providing the prompt including the request to perform the operation as an input to the adapter model, determining whether one or more training criteria associated with the adapter model are satisfied. The prompt is provided as the input to the model responsive to determining that the one or more training criteria associated with the adapter model is satisfied.

In some embodiments, the method further includes, responsive to determining that the one or more training criteria associated with the adapter model are not satisfied, identifying one or more prompt preambles associated with the client account. The one or more prompt preambles indicate the preferred style or the preferred format of the client account. The method further includes providing the prompt and the one or more prompt preambles as an input to the AI model. The method further includes obtaining an output of the AI model based on the provided prompt and the one or more prompt preambles. The method further includes providing the response to the request that is performed using the obtained output of the AI model.

In some embodiments, the method further includes, receiving the one or more prompt preambles from at least one of the client device of the user or another client device of another user associated with the client account, or generating the one or more prompt preambles based on one or more prior electronic documents associated with the client account.

In some embodiments, determining whether the one or more training criteria associated with the adapter model are satisfied includes at least one of determining whether an amount of training data provided to train the adapter model exceeds a threshold amount of training data, or determining whether a performance level of the adapter model exceeds a threshold performance level.

In some embodiments, the method further includes responsive to identifying the adapter model, updating a model pipeline associated with the AI model to include the adapter model at an input of one or more model layers of the AI model associated with the operation of the request.

In some embodiments, the method further includes identifying an additional adapter model associated with the user associated with the client account. The additional adapter model is trained to modify one or more parameters of the AI model based on at least one of a preferred style or a preferred format of the user. The method further includes updating the model pipeline associated with the AI model to include the additional adapter model at an output of the adapter model and at the input of the one or more model layers of the AI model associated with the operation of the request.

In some embodiments, the method further includes determining one or more adapter model priority settings associated with each of the adapter model and the additional adapter model. The method further includes updating one or more bypass settings associated with the model pipeline based on the determined one or more adapter model priority settings. Upon detection of a conflict between the preferred style or the preferred format of the user and the preferred style or the preferred format of the client account, at least one of the adapter model or the additional adapter model is bypassed in the model pipeline in accordance with the determined one or more adapter model priority settings.

In some embodiments, the adapter model is further trained to modify the one or more parameters of the AI model based on one or more preferred data sources of the client account.

In some embodiments, the operation of the request includes at least one of: a content generation operation, a content augmentation operation, a content summarization operation, a content expansion operation, a data classification operation, a knowledge retrieval operation, a data conversion operation, or a program task operation.

In some embodiments, the adapter model is trained by obtaining a set of electronic documents associated with the client account, identifying, of the AI model, one or more layers pertaining to at least one of the set of electronic documents or operations associated with the set of electronic documents, updating a model pipeline associated with the AI model to include the adapter model at a region of an architecture for the AI model that is associated with the identified one or more layers, obtaining a training data set including training data generated based on the at least one of the set of electronic documents or the operations associated with the set of electronic documents, and providing the generated training data set as an input to the AI model to train the adapter model.

In some embodiments, obtaining the training data set includes extracting, from the set of electronic documents, at least one of content of the set of electronic documents or characteristic data indicating one or more characteristics of the content. The method further includes obtaining an output of at least one operation associated with the set of electronic documents. The output of the at least one operation includes one or more of: additional content generated based on the at least one of the content or the one or more characteristics of the content, where the additional content includes at least one of new content or augmented content, a summarization of the content according to at least one of a style or a format indicated by the one or more characteristics of the content, an expanded version of the content according to at least one of the style or the format indicated by the one or more characteristics of the content, a classification of one or more portions of the content based on at least one of the style or the format indicated by the one or more characteristics of the content, answer data in view of one or more knowledge inquiries associated with the content, or an outcome of a program task performed based on the at least one of the content or the one or more characteristics of the content. The method further includes generating an input-output mapping. An input of the input-out mapping includes the at least one of the content or the characteristic data extracted from the set of electronic documents, and an output of the input-output mapping includes the output of the at least one operation associated with the set of electronic documents. The method further includes updating the training data set to include the generated input-output mapping.

In some embodiments, the adapter model includes at least one of a bottleneck adapter model, an invertible adapter model, a compacter adapter model, a prefix tuning adapter model, a low-rank adaptation (LoRA) model, an infused adapter model, a mix-and-match adapter model, a universal parameter-efficient language model tuning (PELT) adapter model, or a prompt tuning model.

An additional or alternative aspect of the disclosure provides a computer-implemented method that includes receiving, from a first user of a platform, a first request to perform an operation associated with an artificial intelligence (AI) model. The method further includes identifying, from a set of adapter models of the platform, a first adapter model associated with at least one of the first user or the first contextual data pertaining to the first request. The method further includes updating a model pipeline associated with the AI model to include the identified first adapter model. The method further includes providing a prompt including the first request to perform the operation as input to the first adapter model. An output of the first adapter model is used by the AI model. The method further includes obtaining a first output of the AI model. The method further includes providing a first response to the first request to the first user. The first response is based on the first output of the AI model.

In some embodiments, the method further includes receiving, from a second user of the platform, a second request to perform the operation associated with the AI model. The method further includes identifying, from the set of adapter models, a second adapter model associated with at least one of the second user or second contextual data pertaining to the second request. The method further includes updating the model pipeline associated with the AI model to include the identified second adapter model. The method further includes providing a prompt including the second request to perform the operation as input to the second adapter model. The method further includes obtaining a second output of the AI model. The second output of the AI model is distinct from the first output of the AI model.

In some embodiments, the first user is associated with a client account of the platform and the first adapter model is associated with the first user. The method further includes identifying, from the set of adapter models, a third adapter model associated with the client account. The method further includes updating the model pipeline associated with the AI model to include the identified third adapter model. An output of the third adapter model is provided as the input to the first adapter model.

In some embodiments, the method further includes determining whether one or more training criteria associated with the first adapter model are satisfied. The model pipeline is updated to include the first adapter model responsive to determining that the one or more training criteria are satisfied.

In some embodiments, determining whether the one or more training criteria associated with the first adapter model are satisfied includes at least one of determining whether an amount of training data provided to train the first adapter model exceeds a threshold amount of training data, or determining whether a performance level of the first adapter model exceeds a threshold performance level.

In some embodiments, updating the model pipeline to include the identified first adapter model includes identifying one or more model layers of the AI model associated with one or more operations of the first request. The method further includes including the first adapter model at an input of the identified one or more model layers.

In some embodiments, the first adapter model is associated with the first user. The first adapter model is trained to modify one or more parameters of the AI model based on one or more preferred data sources of the first user.

In some embodiments, the operation of the request includes at least one of a content generation operation, a content augmentation operation, a content summarization operation, a content expansion operation, a data classification operation, a knowledge inquiry operation, a data conversion operation, or a program task operation.

In some embodiments, the first adapter model is trained by obtaining a set of electronic documents associated with at least one of the first user or the first contextual data pertaining to the first request, identifying, of the AI model, one or more layers pertaining to at least one of the set of electronic documents or operations associated with the set of electronic documents, updating a model pipeline associated with the AI model to include the adapter model at a region of an architecture for the AI model that is associated with the identified one or more layers, obtaining a training data set including training data generated based on the at least one of the set of electronic documents or the operations associated with the set of electronic documents, and providing the generated training data set as an input to the AI model to train the adapter model.

In some embodiments, obtaining the training data set includes extracting, from the set of electronic documents, at least one of content of the set of electronic documents or characteristic data indicating one or more characteristics of the content. The method further includes obtaining an output of at least one operation associated with the set of electronic documents. The output of the at least one operation includes one or more of: additional content generated based on the at least one of the content or the one or more characteristics of the content, where the additional content includes at least one of new content or augmented content, a summarization of the content according to at least one of a style or a format indicated by the one or more characteristics of the content, an expanded version of the content according to at least one of the style or the format indicated by the one or more characteristics of the content, a classification of one or more portions of the content based on at least one of the style or the format indicated by the one or more characteristics of the content, answer data in view of one or more knowledge inquiries associated with the content, or an outcome of a program task performed based on the at least one of the content or the one or more characteristics of the content. The method further includes generating an input-output mapping. An input of the input-out mapping includes the at least one of the content or the characteristic data extracted from the set of electronic documents. An output of the input-output mapping includes the output of the at least one operation associated with the set of electronic documents. The method further includes updating the training data set to include the generated input-output mapping.

In some embodiments, the first adapter model includes at least one of a bottleneck adapter model, an invertible adapter model, a compacter adapter model, a prefix tuning adapter model, a low-rank adaptation (LoRA) model, an infused adapter model, a mix-and-match adapter model, a universal parameter-efficient language model tuning (PELT) adapter model, or a prompt tuning model.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 is a block diagram of an example platform, an example adapter model manager, and an example prompt preamble manager, in accordance with implementations of the present disclosure.

FIG. 3 depicts a flow diagram of an example method for training an AI model, in accordance with implementations of the present disclosure.

FIG. 4 depicts a flow diagram of an example method for obtaining a response to a query using artificial intelligence (AI), in accordance with implementations of the present disclosure.

FIGS. 5A and 5B depict example model pipelines for a system including an AI model, in accordance with implementations of the present disclosure.

FIG. 6 depicts a flow diagram of another example method for obtaining a response to a query using artificial intelligence (AI), in accordance with implementations of the present disclosure.

FIGS. 7A and 7B depict other example model pipelines for a system including an AI model, in accordance with implementations of the present disclosure.

FIG. 8 depicts a flow diagram of another example method for obtaining a response to a query using artificial intelligence (AI), in accordance with implementations of the present disclosure.

FIGS. 9A-9D depict an example of including a prompt preamble as an input to an AI model, in accordance with implementations of the present disclosure.

FIG. 10 is a block diagram illustrating an exemplary computer system, in accordance with implementations of the present disclosure.

### DETAILED DESCRIPTION

Aspects of the present disclosure relate to customized query responses using artificial intelligence (AI). A system can include one or more AI models (e.g., large language models (LLMs)) that are trained to perform various tasks associated with the system. For example, a system for a collaborative document platform and/or a productivity platform can include one or more AI models that are trained to perform tasks such as content generation, content summarization, content expansion, data classification, knowledge retrieval, and so forth, as well as performing operations on behalf of a requesting user (e.g., creating a calendar invitation, generating and transmitting an electronic message, etc.). Although AI models are designed to perform a variety of tasks and operations, making them versatile tools across numerous applications, individual users often utilize these models for specific tasks that are particularly relevant to their unique needs. When multiple users engage the AI models (and/or systems that implement or support AI models) for the same general task, such as document summarization, the purposes for which they use the model responses can vary significantly. For example, a user within a legal department of an organization might prompt an AI model to summarize a document with a focus on legal implications and compliance, whereas another user within a sales department of the organization might prompt the AI model to summarize the document with a focus on marketing strategies and customer engagement. Despite both users requesting the AI model to perform the identical task of summarizing the document, the use of the output and the intent behind the request differ based on the users' goals and context.

In some instances, a user that is dissatisfied with the output of an AI model and/or wanting the output to be presented according to a different style or format may re-prompt the AI model, sometimes with additional information about the preferred output style or format. When a user prompts an AI model, substantial computing resources are consumed, including but not limited to high-performance processors such as graphics processing units (GPUs), tensor processing units (TPUs), memory handling large data set, and so forth. If a user is dissatisfied with the output of an AI model and re-prompts the model, these computing resources are implicated again, as the system reprocesses the input. The repeated engagement of the underlying computing resources supporting an AI model can lead to an increased computational load, higher energy consumption, and longer processing times, which can impact the overall efficiency and latency of the system.

Training an AI model to produce outputs in accordance with a user's style or formatting preference can consume a similar or larger amount of computing resources as repeated engagement with an AI model. AI models are trained using vast datasets that encompass diverse language patterns and knowledge domains and the training process involves multiple stages, including data preprocessing, model training, fine-tuning, and evaluation, each demanding a substantial computational power and memory. To train an AI model to produce outputs according to a user's style or formatting preferences for electronic mail (e-mail) messages, for example, the system may collect and store a large number (e.g. hundreds, thousands, etc.) of prior e-mail messages written by the user, extract style and/or formatting data from content of the collected e-mail messages, generate training data based on the extracted style and/or formatting data, and, following training of the AI model using the generated training data, subject the AI model to testing and validation processes to determine whether the AI model is sufficiently trained to generate e-mail messages that align with user's style or formatting preferences. In systems where AI models are accessible to hundreds of thousands or even millions of users, the above described training process becomes exponentially more demanding. Customizing an AI model for each individual user involves a considerable investment of time and computational resources (e.g., processing cycles, memory storage, etc.), making it a complex and resource-intensive endeavor to maintain personalized output capabilities for a large user base.

Implementations of the present disclosure address the above and other deficiencies by providing methods and systems for customized query responses using artificial intelligence (AI). In some embodiments, a system can provide users with access to one or more AI models. For example, the system can include one or more platforms, such as a collaborative document platform and/or a productivity platform, that provide users with access to AI models trained to perform tasks associated with functionalities or services of the platform(s) (e.g., content generation, content augmentation, content summarization, content expansion, data classification, knowledge retrieval, data conversion, etc.). In some embodiments, the system can train and/or maintain one or more adapter models. An adapter model (also referred to as an adapter herein) may include a set of trainable modules or components that can be inserted into a pre-trained AI model's architecture to allow for task-specific fine-tuning of the AI model. In some instances, the adapter model can be trained according to low-rank decomposition techniques and added to layers of the AI model associated with the tasks of the functionalities or services of the platform(s). A prompt for the AI model can be provided as an input to an adapter model inserted into the AI model's architecture. An output of the adapter model can be applied to the AI model when handling the prompt, for example, an output of the adapter model can be provided as an input to the AI model. The output of the adapter model can include the provided prompt and an indication of fixed values for one or more parameters to be applied by the AI model when handling the prompt. The fixed values for the parameters can impact the output of the AI model when applied by the AI model to handle the prompt, as indicated below.

In some embodiments, the adapter model can be trained using a training data set generated based on documents having a preferred style or format associated with users of a client account of the platform(s). A client account can be associated with one or more users of the platform(s) and can define settings, permissions, and/or a workspace for the one or more users accessing tools or functionalities of the platform(s). Upon receiving a query associated with the functionalities or services of the platform(s), the system can provide a prompt associated with the query as an input to the adapter model included in the AI model architecture. An output of the adapter model can include the provided prompt and an indication of fixed values for one or more parameters to be evaluated by the AI model handling the prompt, in view of the preferred style or format defined by the one or more documents of the training data set. The AI model can apply the fixed values for the parameters to handle the prompt, which can cause an output of the AI model to have a style or format matching, or approximately matching, the preferred style or format of the client account, per the training data set used to train the adapter model.

In some embodiments, the system can include the adapter model for a client account in the model architecture of the AI model upon a determination that one or more training criteria associated with the adapter model are satisfied (e.g., a threshold amount of training data has been collected and/or provided to train the adapter model, a performance level of the adapter model exceeds a threshold performance level, etc.). Upon a determination that the training criteria are not satisfied, the system can generate the training data set based on incoming queries from users associated with the client account and/or can provide prompts associated with the incoming queries as direct inputs to the AI model (e.g., as opposed to the adapter model). In some embodiments, until the training criteria associated with the adapter model are satisfied, the system can include one or more prompt preambles associated with the client account with the prompts provided as inputs to the AI models. A prompt preamble refers to data or information that indicates a preferred style or format of an output of the AI model defined for a client account of the system. In some embodiments, a user associated with the client account can provide the prompt preamble for the account (e.g., via a user interface (UI) of a client device). In other or similar embodiments, the system can derive the prompt preamble based on historical or test data for the client account. Upon receiving a query associated with the client account, the system can identify one or more prompt preambles associated with the client account and can include the identified prompt preamble(s) with the prompt for the received query as an input to the AI model. An output of the AI model can have a style or format that matches, or approximately matches, the style or format indicated by the prompt preamble.

In some embodiments, the model architecture for the AI model may be able to support a limited number of adapter models at a given time. For example, the model architecture can include a fixed number of slots for inclusion of an adapter model, which is smaller than the total number of adapter models trained and/or maintained by the system. In some embodiments, the system can include an adapter model for a client account in a slot of the AI model architecture upon receipt of a query from a user associated with the client account. If, upon receiving the query, no slots are available for inclusion of an adapter model for the client account, the system can remove another adapter model from an occupied slot of the model architecture (e.g., based on an adapter model replacement scheme) and can include the adapter model associated with the received query in such slot.

Aspects of the present disclosure provide techniques for providing customized query responses to clients and or users accessing systems implementing AI models, without training the AI models directly on preferred style or format settings for the clients and/or users. When a user (or set of users associated with a client account) initially accesses an AI model of a system, the system can concurrently train an adapter model for the user based on the user's style and/or formatting preferences and handle inquiries received from the user by providing prompts associated with such inquiries as direct inputs to the AI model. Upon completion of training of the adapter model (e.g., based on one or more training criteria), the system can include the adapter model in the model architecture for the AI model, and incoming queries can be handled by the AI model in view of the output provided by the trained adapter model. Accordingly, the system is able to obtain responses to the user's query in accordance with the preferred style and/or formatting preferences of the user without a resource intensive training process being performed for the AI model. Embodiments of the present disclosure enable the system to provide relevant and useful responses to the user, which reduces the number of re-prompts initiated by the user, which in turn reduces the overall number of computing resources consumed by the system and improves the overall efficiency and latency of the system. Additionally, prior to including the trained adapter model in the AI model architecture, the system can include a prompt preamble that defines the user's preferred style and/or formatting with a prompt provided directly to the AI model, which enables the system to provide relevant and useful responses to the user prior to completion of training of the adapter model.

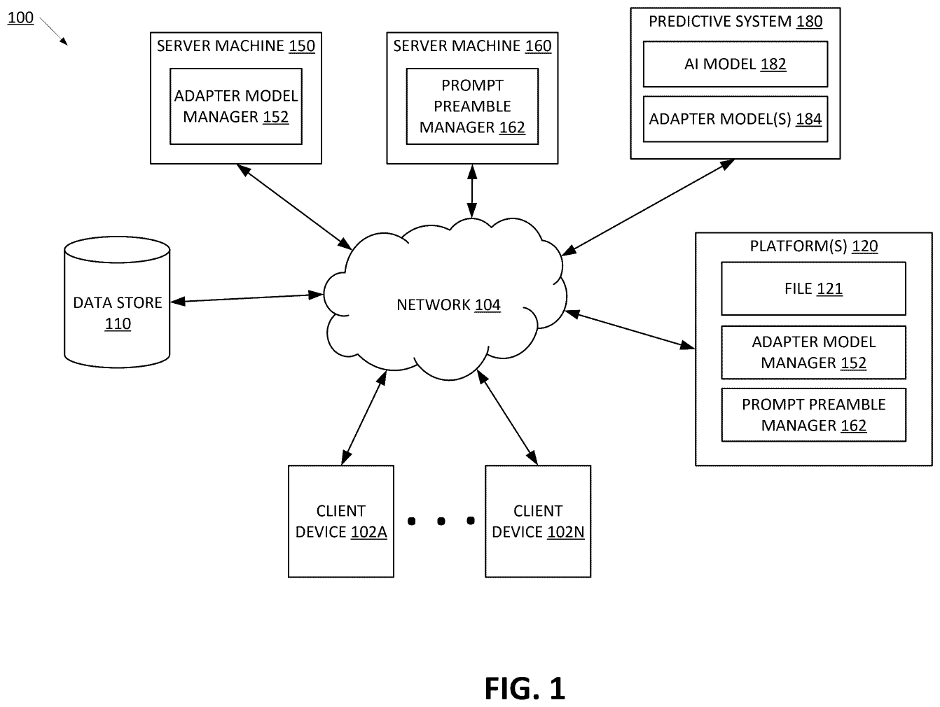

FIG. 1 illustrates an example system architecture 100, in accordance with implementations of the present disclosure. The system architecture 100 (also referred to as “system” herein) includes one or more client devices 102A-N, a data store 110, a platform 120 (e.g., a collaborative document platform, a productivity platform, etc.), one or more server machines (e.g., server machine 150, server machine 160, etc.), and/or a predictive system 180, each connected to a network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In some implementations, data store 110 is a persistent storage that is capable of storing data as well as data structures to tag, organize, and index the data. A data can include one or more media items, in some embodiments, where each media item includes audio data and/or video data, in accordance with embodiments described herein. Data store 110 can be hosted by one or more storage devices, such as main memory, magnetic or optical storage based disks, tapes or hard drives, NAS, SAN, and so forth. In some implementations, data store 110 can be a network-attached file server, while in other embodiments data store 110 can be some other type of persistent storage such as an object-oriented database, a relational database, and so forth, that may be hosted by platform 120 or one or more different machines (e.g., server machines 130-140) coupled to the platform 120 via network 104.

Client devices 102A-N (collectively and individually referred to as client device(s) 102 herein). can include one or more computing devices such as personal computers (PCs), laptops, mobile phones, smart phones, tablet computers, netbook computers, network-connected televisions, etc. In some implementations, a client device 102 can also be referred to as a “user device.” Client devices 102 can include a content viewer. In some implementations, a content viewer can be an application that provides a user interface (UI) for users to view or upload content, such as images, media items, web pages, documents, etc. For example, the content viewer can be a web browser that can access, retrieve, present, and/or navigate content (e.g., web pages such as Hyper Text Markup Language (HTML) pages, digital media items, etc.) served by a web server. The content viewer can render, display, and/or present the content to a user. The content viewer can also include an embedded media player (e.g., a Flash® player or an HTML5 player) that is embedded in a web page (e.g., a web page that may provide information about a product sold by an online merchant). In another example, the content viewer can be a standalone application (e.g., a mobile application or app) that allows users to view digital media items (e.g., digital media items, digital images, electronic books, etc.). In some implementations, the content viewer can be an electronic document platform application for users to generate, edit, and/or upload content for electronic documents on the platform 120. In other or similar implementations, the content viewer can be an electronic messaging platform application (e.g., an electronic mail (e-mail) application) for users to generate and send messages via platform 120. As such, the content viewers can be provided to the client devices 102A-102N by platform 120.

In some implementations, platform 120 can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to provide a user with access to a file 121 (e.g., an electronic document, an e-mail message, etc.) and/or provide the file 121 to the user. For example, platform 120 can be an electronic document platform, such as a collaborative document platform or a productivity platform. The electronic document platform may allow a user to create, edit (e.g., collaboratively with other users), access or share with other users an electronic document stored at data store 110. In another example, platform 120 can allow a user to create, edit, or access electronic messages (e.g., e-mails) addressed to other users of the electronic messaging platform or users of client devices outside of the electronic messaging platform. Platform 120 can also include a website (e.g., a webpage) or application back-end software that can be used to provide a user with access to files 121.

In some embodiments, functionalities of platform 120 can be supported by one or more AI models 182 (collectively and individually referred to as AI models 182 or AI model 182 herein) provided by predictive system 180. An AI model 182 can be trained to perform multiple types of tasks pertaining to the functionalities of platform 120 and/or files 121 of platform 120. Such tasks include, but are not limited to, content generation, content summarization, content expansion, data classification, knowledge retrieval, and so forth, as well as performing operations on behalf of a requesting user (e.g., creating a calendar invitation, generating and transmitting an electronic message, etc.). A user of platform 120 can access the AI model(s) 182 of predictive system 180 via one or more tools or resources of platform 120. For example, platform 120 can provide a client device 102 associated with a user with access to a user interface (UI) for an application that enables a user to create and/or edit a collaborative electronic document (e.g., a collaborative word document, a collaborative spreadsheet document, a collaborative slide presentation document, etc.). The UI can include one or more UI elements that enable the user to engage with the AI model(s) 182 of predictive system 180 in accordance with the functionality of the application. For instance, the UI can include a UI element that enables a user to request generated content from the AI model(s) 182. Upon detecting a user engagement with the UI element (e.g., via a UI of the client device 102), the platform can provide the request to predictive system 180. Predictive system 180 can provide a prompt associated with the request as an input to the AI model(s) 182 and can obtain an output of the model(s), which can include generated content, in accordance with the example. A prompt refers to a natural language text that requests the AI model(s) 182 to perform a specific tasks. In some embodiments, a prompt can include the request provided by the user and/or can include additional or alternative information associated with the request provided by the user. Platform 120 can update the UI provided to the client device 102 to include the generated content for presentation to the user. It should be noted that embodiments of the present disclosure are not limited to the tasks or functions explicitly described herein (e.g., content generation, content summarization, etc.) and embodiments can be applied to any type of task or function that could be performed by an AI model.

In some embodiments, AI model 182 can be an AI model that has been trained on a corpus of textual data. In some embodiments, the AI model 182 can be a model that is first pre-trained on a corpus of text to create a foundational model, and afterwards fine-tuned on more data pertaining to a particular set of tasks to create a more task-specific, or targeted, model. The foundational model can first be pre-trained using a corpus of text that can include text context in the public domain, licensed content, and/or proprietary content. Such a pre-training can be used by the model to learn broad language elements including general sentence structure, common phrases, vocabulary, natural language structure, and any other elements commonly associated with natural language in a large corpus of text. In some embodiments, this first, foundational model can be trained using self-supervision, or unsupervised training on such datasets.

In some embodiments, the AI model 182 can then be further trained and/or fine-tuned on organizational data, including proprietary organizational data. The AI model 182 can also be further trained and/or fine-tuned on organizational data associated with a file 121, including proprietary organizational data associated with a file 121.

In some embodiments, the second portion of training, including fine-tuning, may be unsupervised, supervised, reinforced, or any other type of training. In some embodiments, this second portion of training may include some elements of supervision, including learning techniques incorporating human or machine-generated feedback, undergoing training according to a set of guidelines, or training on a previously labeled set of data, etc. In a non-limiting example associated with reinforcement learning, the outputs of the AI model 182 while training may be ranked by a user, according to a variety of factors, including accuracy, helpfulness, veracity, acceptability, or any other metric useful in the fine-tuning portion of training. In this manner, the AI model 182 can learn to favor these and any other factors relevant to users within an organization, or associated with a virtual meeting, when generating a response. In such a way, a foundational model can be further trained to perform within a virtual meeting, and provide useful information, as well as help to accomplish useful tasks associated with the virtual meeting.

In some embodiments, the AI model 182 may include one or more pre-trained models, or fine-tuned models. In a non-limiting example, in some embodiments, the goal of the “fine-tuning” may be accomplished with a second, or third, or any number of additional models. For example, the outputs of the pre-trained model may be input into a second AI model that has been trained in a similar manner as the “fine-tuned” portion of training above. In such a way, two more AI models may accomplish work similar to one model that has been pre-trained, and then fine-tuned.

In one embodiment, the AI model 182 may be one or more of decision trees, random forests, support vector machines, or other types of machine learning models. In one embodiment, the AI model 145 may be one or more artificial neural networks (also referred to simply as a neural network). The artificial neural network may be, for example, a convolutional neural network (CNN) or a deep neural network. In one embodiment, processing logic performs supervised machine learning to train the neural network.

Artificial neural networks generally include a feature representation component with a classifier or regression layers that map features to a target output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). The neural network may be a deep network with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. Neural networks may learn in a supervised (e.g., classification) and/or unsupervised (e.g., pattern analysis) manner. Some neural networks (e.g., such as deep neural networks) include a hierarchy of layers, where the different layers learn different levels of representations that correspond to different levels of abstraction. In deep learning, each level learns to transform its input data into a slightly more abstract and composite representation.

In some embodiments, the AI model 182 may be one or more recurrent neural networks (RNNs). An RNN is a type of neural network that includes a memory to enable the neural network to capture temporal dependencies. An RNN is able to learn input-output mappings that depend on both a current input and past inputs. The RNN will address past and future measurements and make predictions based on this continuous measurement information. One type of RNN that may be used is a long short term memory (LSTM) neural network.

As indicated above, the AI model 182 may be one or more generative AI models, allowing for the generation of new and original content. The generative AI model can use other machine learning models including an encoder-decoder architecture including one or more self-attention mechanisms, and one or more feed-forward mechanisms. In some embodiments, the generative AI model can include an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model can also utilize the previously discussed deep learning techniques, including recurrent neural networks (RNNs), convolutional neural networks (CNNs), or transformer networks. Further details regarding generative AI models are provided herein.

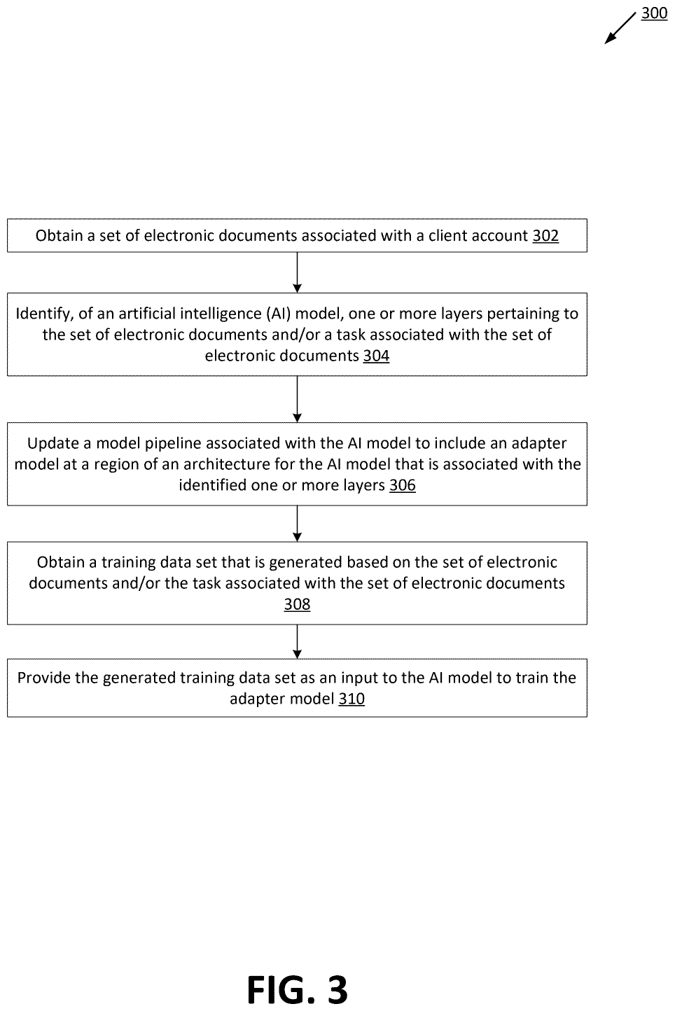

In some embodiments, predictive system 180 can additionally include one or more adapter models 184 (collectively and individually referred to as adapter models 184, adapters 184, adapter model 184, or adapter 184 herein). An adapter model includes a set of trainable modules or components that can be inserted into a pre-trained AI model's architecture (e.g., architecture for AI model 182) to allow for task-specific fine-tuning of the AI model. An AI model's architecture refers to the underlying structure and design for the AI model, which can include multiple layers of interconnected neurons organized in a way that allows for deep learning and complex pattern recognition. A model architecture can include or otherwise define a model pipeline, which refers to a series of processes or operations that are performed during deployment of the AI model. In some embodiments, an adapter model 184 can be trained according to a low-rank decomposition technique and added to layers of the AI model associated with tasks of the functionalities or services of the platform 120. A prompt for the AI model 182 can be provided as input to an adapter model 184 inserted into the model architecture of AI model 182 and an output of the adapter model 184 can be provided as an input to AI model 182. The output of the AI model 184 can include the provided prompt and an indication of fixed values for one or more parameters to be applied by the AI model 182 when handling the prompt. The AI model 182, when handling the prompt received from the adapter model 184, modifies the one or more parameters to have the fixed values indicated by the output of the adapter model 184, which can cause an output of AI model 182 to be obtained in accordance with the training of the adapter model 184. Further details regarding training the adapter models 184 are described below with respect to FIG. 3.

An adapter model can include, but is not limited to, a bottleneck adapter model, an invertible adapter model, a compacter adapter model, a prefix tuning adapter model, a low-rank adaptation (LoRA) model, an infused adapter model, a mix-and-match adapter model, a universal parameter-efficient language model tuning (PELT) adapter model, or a prompt tuning model.

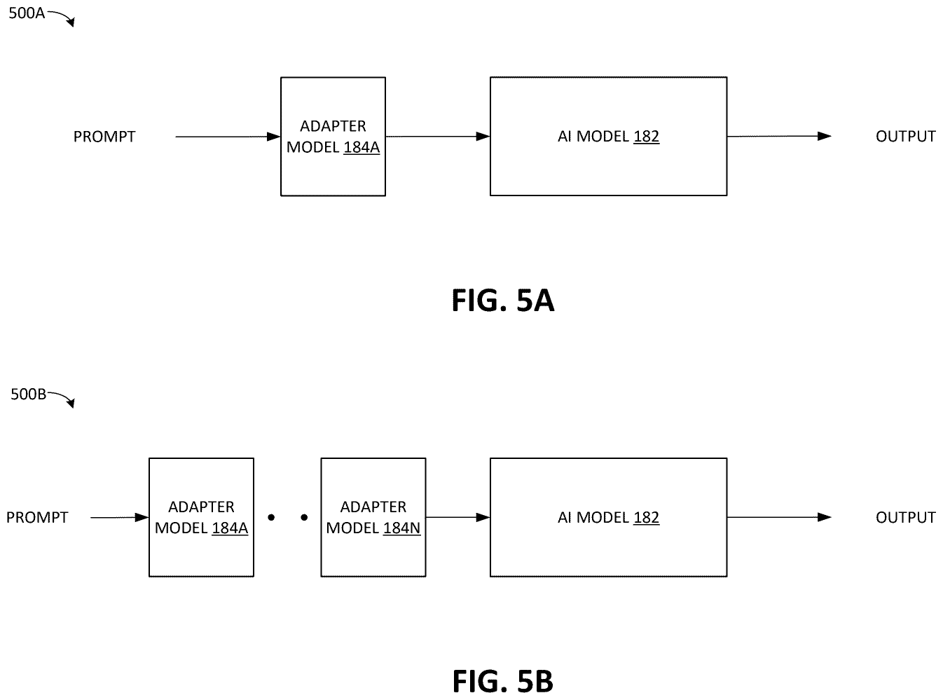

In some embodiments, predictive system 180 can train an adapter model 184 using a training data set generated based on documents having a preferred style or format associated with a user of platform 120 and/or users of a client account of platform 120. A client account can be associated with one or more users of platform 120 and can define settings, permissions, and/or a workspace for the users accessing tools and/or functionalities of platform 120. In an illustrative example, a client account of platform 120 can be associated with an organization (e.g., a company, etc.), where one or more users of platform 120 are associated with the organization (e.g., as employees of the company). Users associated with the organization can access tools or functionalities of platform 120 (e.g., in accordance with their role in the organization). In some embodiments, the training data set used to train the model adapter 184 can include and/or be based on files 121 including content having the preferred style and/or format associated with the organization. As described herein, upon training of the adapter model 184 for the organization, predictive system 180 can include the trained adapter model 184 in the model pipeline of the architecture for model 182. When a request is received from a client device 102 of a user associated with the client account, predictive system 180 can provide a prompt associated with the request as an input to the adapter model 184 for the client account. In additional or alternative embodiments, predictive system 180 can train an adapter model 184 using a training data set generated based on document having a preferred style or format associated with an individual user associated with the organization. In some embodiments, the model pipeline of AI model 182 can be updated to include both the adapter model 184 for the client account and the adapter model 184 for the individual user. When a request is received from a client device 102 of the user, the prompt associated with the request can be provided as an input to both the adapter model 184 for the client account and the adapter model 184 for the individual user. The output of the AI model 182 can therefore incorporate the style and/or formatting preferences of the client account and individual user, in some embodiments. Further details regarding including adapter models 184 in the model pipeline for AI model 182 are described below with respect to FIGS. 5A-5B.

As illustrated in FIG. 1, platform 120 can include an adapter model manager 152. Adapter model manager 152 can coordinate training and use of adapter models 184 associated with one or more users of the platform 120. As described above, platform 120 can receive a request from a user of a client device 102 relating to a task of AI model 182. Adapter model manager 152 can determine one or more adapter models 184 associated with the user and can transmit one or more signals to cause the determined adapter model(s) 184 to be included in the model pipeline of AI model 182 during handling of a prompt for the request. In additional or alternative embodiments, adapter model manager 152 can collect training data for training adapter model(s) 184 and can coordinate and/or facilitate training of the adapter model(s) 184 by predictive system 180 using the collected training data. Further details regarding adapter model manager 152 are described herein. It should be noted that although FIG. 1 illustrates adapter model manager 152 as a component of platform 120, adapter model manager 152 can also or alternatively be a component of predictive system 180.

In some embodiments, platform 120 can additionally or alternatively include a prompt preamble manager 162, which can manage one or more prompt preambles associated with client accounts and/or users of platform 120. A prompt preamble refers to data or information that indicates a preferred style or format of an output of the AI model 182, as defined for a client account or a user of platform 120. In some embodiments, a prompt preamble can be provided with a prompt as an input to AI model 182 and an output of AI model 182 can have a style or format that matches, or approximately matches, the preferred style or format indicated by the prompt preamble. In some embodiments, adapter model manager 152 can determine that an adapter model 184 for a client account and/or a user is not yet sufficiently trained (e.g., in view of one or more training criteria) to be included in the model pipeline of the model architecture for AI model 182. In such embodiments, prompt preamble manager 162 can identify the prompt preamble associated with the client account and/or the user and can provide the prompt preamble with the prompt as an input to the AI model 182. Further details regarding prompt preambles and prompt preamble manager 162 are described herein. It should be noted that although FIG. 1 illustrates prompt preamble manager 162 as a component of platform 120, prompt preamble manager 162 can also or alternatively be a component of predictive system 180.

It should be noted that although FIG. 1 illustrates adapter model manager 152 and prompt preamble manager 162 as part of platform 120, in additional or alternative embodiments, one or more portions or components of adapter model manager 152 and/or prompt preamble manager 162 can reside and/or be executed at client device(s) 102. In other or similar embodiments, one or more components of adapter model manager 152 and prompt preamble manager 162 can reside on one or more server machines that are remote from platform 120. In an illustrative example, adapter model manager 152 can reside at server machine 150 and prompt preamble manager 162 can reside at server machine 160, in additional or alternative embodiments. It should be noted that in some other implementations, the functions of platform 120, server machine 150, server machine 160, and/or predictive system 180 can be provided by more or a fewer number of machines. For example, in some implementations, components and/or modules of platform 120, server machine 150, server machine 160, and/or predictive system 180 may be integrated into a single machine, while in other implementations components and/or modules of any of platform 120, server machine 150, server machine 160, and/or predictive system 180 may be integrated into multiple machines. In addition, in some implementations, components and/or modules of server machine 150, server machine 160, and/or predictive system 180 may be integrated into platform 120.

In general, functions described in implementations as being performed platform 120, server machine 150, server machine 160, and/or predictive system 180 can also be performed on the client devices 102A-N in other implementations. In addition, the functionality attributed to a particular component can be performed by different or multiple components operating together. Platform 120 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 120.

Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

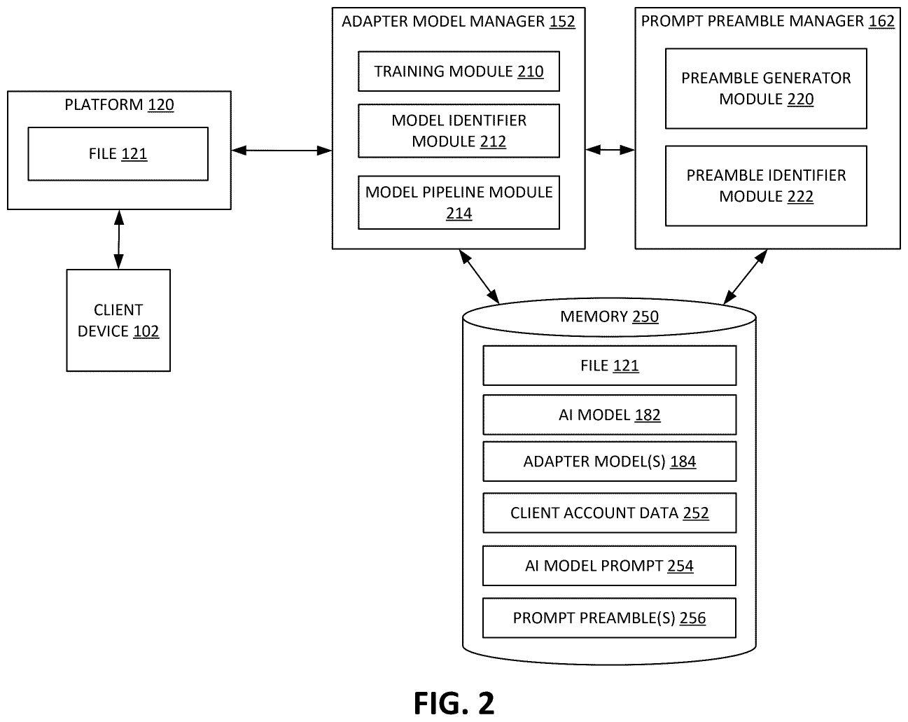

FIG. 2 is a block diagram of an example platform 120, an example adapter model manager 152, and an example prompt preamble manager 162, in accordance with implementations of the present disclosure. As described above, platform 120 can provide users (e.g., individual users, users associated with a client account, etc.) with access to AI model 182, which is trained to perform one or more tasks associated with functionalities of platform 120. As described above, adapter model manager 152 can coordinate training and use of adapter models 184 associated with a client account of platform 120 and/or individual users of platform 120. Also described above, prompt preamble manger 162 can manage one or more prompt preambles 254 associated with client accounts and/or users of platform 120. Details regarding adapter model manager 152 and prompt preamble manager 162 are provided herein with respect to FIGS. 2-9.

As illustrated in FIG. 2, platform 120, adapter model manager 152, and/or prompt preamble manager 162 can be connected to a memory 250. Memory 250 can include data store 110 and/or one or more portions of data store 110, in some embodiments. In other or similar embodiments, memory 250 can additionally or alternatively include memory (or a portion of memory) of one or more of client devices 102A-N. In yet other or similar embodiments, memory 250 can include memory of any component or device of system 100, or of other components or devices that are connected to or otherwise accessible to system 100.

As described herein, a user of client device 102 may engage with one or more applications of platform 120 (e.g., a collaborative document application, an electronic communication application etc.). Platform 120 can provide the user with access to AI model 182 in accordance with one or more functionalities or features of the applications. In some embodiments, platform 120 can maintain one or more client accounts that are associated with one or more users of platform 120. A client account can be associated with a single user (e.g., an individual user) of platform 120 or with multiple users (e.g., users associated with an organization or an enterprise). It should be noted that although some embodiments of the present disclosure are described with respect to a client account associated with one or more users, embodiments can be applied in any instance that involves a user engaging with an AI model of a system, regardless of whether the user is associated with a client account.

As illustrated in FIG. 2, adapter model manager 152 can include a training module 210, a model identifier module 212, and/or a model pipeline module 214. Training module 210 can coordinate training of an adapter model 184, as described with respect to FIG. 3. FIG. 3 depicts a flow diagram of an example method 300 for training an AI model, in accordance with implementations of the present disclosure. Method 300 can be performed by processing logic that can include hardware (circuitry, dedicated logic, etc.), software (e.g., instructions run on a processing device), or a combination thereof. In one implementation, some or all the operations of method 300 can be performed by one or more components of system 100 of FIG. 1. In some embodiments, some or all of the operations of method 300 can be performed by adapter model manager 152 and/or predictive system 180. For example, some or all of operations of method 300 can be performed by training module 210 of adapter model manager 152.

At block 302, processing logic obtains a set of electronic documents associated with a client account. In some embodiments, training module 210 can obtain a set of files 121 for electronic document associated with a client account and/or users associated with the client account. In some embodiments, a user associated with the client account (e.g., an administrator, etc.) can provide the set of files 121 to training module 210 (e.g., via a client device 102). In other or similar embodiments, training module 210 can identify files 121 for electronic documents associated with the client account and/or the users associated with the client account (e.g., from memory 250). For example, memory 250 can store files 121 associated with users of platform 120. Each file can be associated with one or more identifiers, which indicate a client account associated with the respective file 121 and/or a user or client device 102 associated with the respective file 121. Training module 210 can identify, of the stored files 121, one or more files 121 associated with an identifier indicating the client account, a user associated with the client account, and/or a client device 102 associated with a user associated with the client account. Upon identifying the one or more files 121, training module 210 can include the identified files 121 in the set of files 121 for training the adapter model 184.

In some embodiments, the set of files 121 may be associated with electronic documents each having a distinct document type (e.g., a word document type, a spreadsheet document type, a slide presentation document type, an e-mail document type, etc.). Training module 210 can separate the files 121 of the set of files 121 into one or more file subsets each corresponding to a distinct document type, in some embodiments. For example, training module 210 can include each file associated with an electronic document having a word document type with a first file subset, each file associated with an electronic document having a spreadsheet document type with a second file subset, and so forth. In other or similar embodiments, electronic documents of the set of files 121 may include content associated with distinct task types. A task type refers to a type of a task that may be performed for the content of the electronic document. For example, content of an electronic document having a word document type and content of an electronic document having an e-mail message type may both include text that could be subject to a content summarization task or a content elongation task of the AI model 182. In some embodiments training module 210 can further separate files 121 (or content of the electronic documents of files 121) into additional subsets based on the task type associated with content of the electronic documents.

At block 304, processing logic identifies, of an AI model, one or more layers pertaining to the set of electronic documents and/or a task associated with the set of electronic documents. As indicated above, AI model 182 can be a large language model that is composed of multiple layers that work together to process and generate human language. Thus, AI model 182 can include a transformer layer, which includes self-attention mechanisms and feed-forward neural networks. Each transformer layer can include a multi-head self-attention sub-layer, which allows the model to attend to information from multiple representation subspaces, followed by a feed-forward sub-layer that applies a series of linear transformations and non-linear activations to the data. In some embodiments, one or more layers of AI model 182 can correspond to respective types of electronic documents and/or types of tasks for content of electronic documents of platform 120 (e.g., as provided by the model architecture defined by developers/operators of platform 120). In some embodiments, training module 210 can identify the layers of AI model 182 that correspond to the respective types of electronic documents and/or types of tasks for content of electronic documents, as described above. In some embodiments, training module 210 can identify the layers based on a notification provided by a developer or operator of system 100 (e.g., via a client device 102). In other or similar embodiments, training module 210 can identify the layers based on fine-tuning data and/or pattern analysis data collected for AI model 182 (e.g., during a training process and/or a pattern analysis process performed for the AI model 182). In some embodiments, AI model 182 can be or include a transformer-based model, such as a LLM. In such embodiments, the identified layers may reside at feed-forward layers and/or attention layers of a transformer block of the AI model 182.

At block 306, processing logic updates a model pipeline associated with the AI model to include an adapter model at a region of an architecture for the AI model that is associated with the identified one or more layers. In some embodiments, training module 210 can update the model pipeline to include the adapter model 184 at a region of the model architecture associated with the identified layers described with respect to block 306. For example, if AI model 182 is a LLM, training module 210 can insert the adapter model 184 after a feed-forward layer of AI model 184 and/or before a residual connection in each transformer block for the identified layers of block 306. In some embodiments, training module 210 can insert update the model pipeline to include the adapter model by inserting one or more matrices (e.g., low-rank matrices) in the chosen layers. For example, training module 210 can decompose weight matrices in the chosen layers into low-rank matrices, e.g., using techniques such as single value decomposition.

At block 308, processing logic obtains a training data set that is generated based on the set of electronic documents and/or the task associated with the set of electronic documents. In some embodiments, training module 210 can obtain the training data set extracting, from the set of electronic documents obtained according to block 302, content of the electronic documents and/or characteristic data indicting characteristics of the content. Content of the electronic document can include, but is not limited to, text content, image content (e.g., images, videos, etc.), audio content, reference content (e.g., content that references data or information accessible via a source outside of the electronic document), and so forth. A characteristic of the content can include, but is not limited to, a subject of the content (e.g., science-based content, technology-based content, legal-based content, etc.), a domain associated with the content (e.g., legal domain, medical domain, etc.), a language associated with the content (e.g., English, Spanish, etc.), a dialect associated with the content, a style of the content (e.g., formal, informal, a narrative style, a descriptive style, a persuasive style, etc.), a structure of the content (e.g., a sentence structure type, a length of the content, an organization of the content, etc.), background information of the content, temporal information of the content, data quality information of the content (e.g., grammar patterns, spelling patterns, error patterns, etc.), and so forth. In some embodiments, training module 210 can obtain the characteristic data for the content by performing one or more characteristic analysis operations with respect to the content of the electronic documents and/or by providing the content and/or the electronic document as an input to a content characteristic model trained to predict characteristics of content.

In some embodiments, training module 210 generate an input-output mapping, the input mapping including the content and/or the characteristic data extracted from the set of electronic documents and the output including an output of at least one operation of the set of electronic documents. The operation can include, but is not limited to, a content generation operation (e.g., where an output includes additional content generated based on the content and/or the characteristics of the content, the additional content including new content or augmented content), a content summarization operation (e.g., where an output includes a summarization of the content according to the style and/or the format indicated by the characteristics of the content), a content expansion operation (e.g., where an output includes an expanded version of the content according to the style and/or the format indicated by the characteristics of the content), a content classification operation (e.g., where an output includes a classification of one or more portions of the content based on the style and/or the format indicated by the characteristics of the content), a knowledge retrieval operation (e.g., were an output includes answer data in view of one or more knowledge inquiries associated with the content), an application-specific operation (e.g., where an output includes an outcome of a program task for the application based on the content and/or the characteristics of the content), and so forth. In some embodiments, training module 210 can execute one or more instructions to perform the operation with respect to the content of the electronic document. In other or similar embodiments, another module or component of system 100 may perform the operation. Training module 210 can obtain an output of the operation by accessing the output stored at a memory (e.g., 250) after completion of the operation. Upon generating the input-output mapping, training module 210 can update a training data set for the adapter model 184 to include the input-output mapping.

At block 310, processing logic provides the generated training data set as an input to the AI model to train the adapter model. In some embodiments, upon updating the training data set to include the input-output mapping, training module 210 can determine whether the training data set includes a threshold amount of training data sufficient for training the adapter model 194. Upon determining that the training data set includes the threshold amount of training data, training module 210 can, in some embodiments, perform one or more data labeling and/or data preprocessing operations (e.g., tokenization operations, data cleaning operations, normalization operations, etc.). Training module 210 can then provide the training data set as an input to the adapter model 184 included in the model architecture of AI model 182. Upon providing the training data set to adapter model 184, the data of the training data set may be passed to AI model 182 and the parameter values and/or weights of the layers pertaining to the electronic documents and/or tasks associated with the electronic documents may be updated during the training. Adapter model 184 can detect the updates to the parameter values and/or weights of the layers to which the model 184 is connected (e.g., based on back-propagation) and can determine the updated parameter values and/or weights based on the detection. In some embodiments, adapter model 184 can additionally or alternatively detect parameter values and/or weights of the layers that are not updated during the training. The values of the decomposed weight matrices may be updated based on the determined updates to the parameter values and/or weights, per the training of the adapter model 184. In accordance with embodiments described herein, during an inference phase, the adapter model can predict modified values of one or more parameters of AI model 182 based on the training performed using the training data set. The modified values can be applied to the parameters and/or weights of the layers of AI model 182 while handling a prompt associated with a user request to perform a task, as described herein.

In some embodiments, training module 210 can continuously update the training data set and train the adapter model 184 using the updated training data set as platform 120 receives requests to perform operations associated with tasks of platform 120 from an associated user, or group of users associated with a client account. During such training phase, platform 120 can provide prompts of the requests directly as inputs to the AI model 182. In some embodiments, platform 120 can provide the prompts of the requests to the AI model 182 directly via a first data channel and can provide the prompts of the requests to the adapter model 184 via a second channel (e.g., simultaneously). In such embodiments, AI model 182 can handle the tasks of the user request (e.g., in real time or approximately real time) during training of adapter model 184. As will be described in further detail below, the adapter model 184 may be applied by platform 120 to handle prompts for incoming requests by the user (or users associated with the client account) upon a determination that one or more training criteria associated with the adapter model 184 are satisfied.

In some embodiments, upon completion of the training phase for adapter model 184, training module 210 can update the model pipeline for AI model 182 to remove the adapter model 184 from the model architecture. The adapter model 184 can be stored at memory 250, in some embodiments. In other or similar embodiments, the adapter model 184 can be stored at another memory of system 100 (or a memory accessible to system 100) and training module 210 can store a mapping between a memory address for the region of memory that stores adapter model 184 and an identifier for the user and/or the client account associated with the adapter model 184 at memory 250. In yet other or similar embodiments, upon completion of the training phase for adapter model 184, training module 210 may not remove adapter model 184 from the model architecture of AI model 182 and instead may perform one or more operations to deactivate the connections between adapter model 184 and the layers of AI model 184. In such embodiments, training module 210 may update memory 250 to include an identifier for a region of the architecture for AI model 184 that includes adapter model 184.

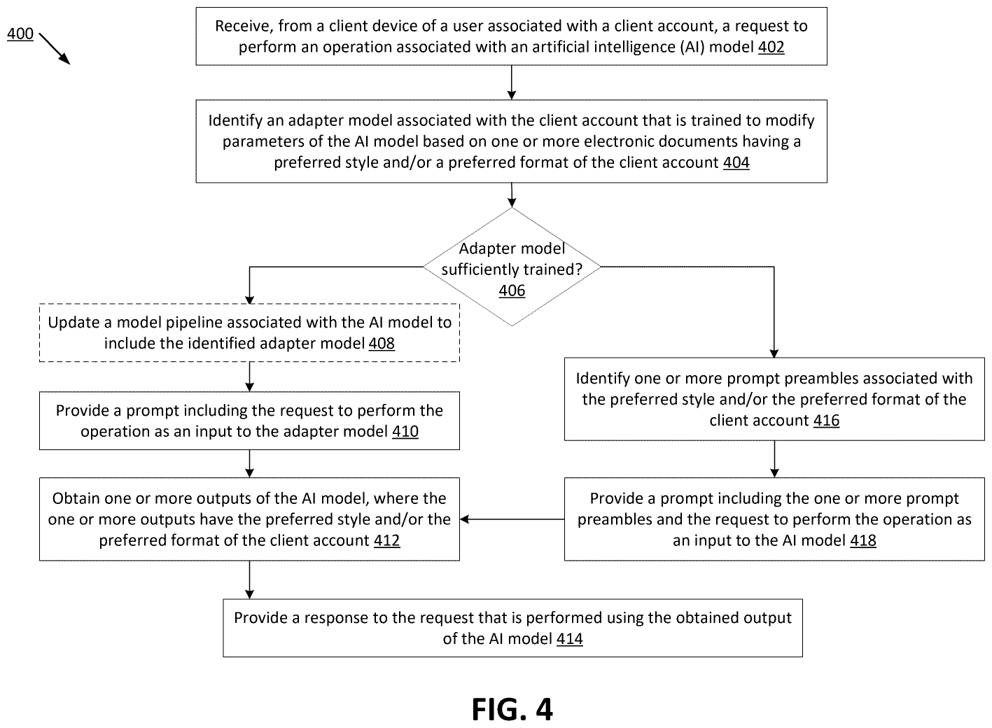

Referring back to FIG. 2, during or after training of adapter model 184 (as described with respect to FIG. 3), a user can engage with electronic documents of platform 120. During such engagement, a client device 102 of the user can transmit requests to perform operations associated with AI model 182. Upon receiving the requests, model identifier module 212 and/or model pipeline module 214 of adapter model manager 152 can identify one or more adapter models 184 associated with the user and, upon determination that the adapter model(s) 184 are sufficiently trained, can update the model pipeline of AI model 182 to include the adapter model(s) 184 in the model architecture. Details regarding model identifier module 212 and model pipeline module 214 are described with respect to FIG. 4.

FIG. 4 depicts a flow diagram of an example method 400 for obtaining a response to a query using artificial intelligence (AI), in accordance with implementations of the present disclosure. Method 400 can be performed by processing logic that can include hardware (circuitry, dedicated logic, etc.), software (e.g., instructions run on a processing device), or a combination thereof. In one implementation, some or all the operations of method 400 can be performed by one or more components of system 100 of FIG. 1. In some embodiments, some or all of the operations of method 300 can be performed by adapter model manager 152 and/or predictive system 180. For example, some or all of operations of method 300 can be performed by model identifier module 212 and/or model pipeline module 214 of adapter model manager 152.

At block 402, processing logic receives, from a client device of a user associated with a client account, a request to perform an operation associated with an AI model. As described above, a user can engage with one or more electronic documents of platform 120 (e.g., via a client device 102). In some embodiments, platform 120 can receive one or more requests from the client device 102 associated with the user based on the user engagement. In an illustrative example, the user can engage with an e-mail application of platform 120 to compose an e-mail message. In some embodiments, the client device 102 may transmit a request to platform 120 to perform a content generation operation, a content summarization operation, a content elongation operation, etc. upon detecting that the user has engaged with a UI of the e-mail application. In other or similar embodiments, the client device 102 may transmit a request to platform 120 to perform such operation upon detecting that the user has engaged with a UI element associated with the operation via the UI of the e-mail application.

At block 404, processing logic identifies an adapter model associated with the client account that is trained to modify parameters of the AI model based on one or more electronic documents having a preferred style and/or a preferred format of the client account. As described herein, training module 210 may store trained adapter models 184 at memory 250 with an identifier of a user and/or a client account associated with the adapter model 184. In other or similar embodiments, training module 210 may store a mapping between an identifier of a user and/or a client account and a memory address for a region of another memory that stores the trained adapter model 184. In yet other or similar embodiments, training module 210 may store a mapping between an identifier of a user and/or a client account and a region of a model architecture of AI model 182 that includes the adapter model 184 (e.g., which may be disconnected from layers of AI model 182). Model identifier module 212 may identify a location of the adapter model 184 based on at least one of the above described mappings of memory 250. In some embodiments, the adapter model 184 associated with the user and/or the client account may be subject to a training phase, as described above, and therefore may be included in the model pipeline for AI model 182. Upon determining that the trained adapter model 184 and/or a mapping for the trained adapter model 184 is not stored at memory 250, model identifier module 212 may query training module 210 whether an adapter model 184 associated with the user and/or the client account is subject to the training phase. Model identifier module 212 can receive a response from training module 210 that indicates whether the adapter model 184 is subject to the training phase and/or a region of the model architecture that includes the adapter model 184.

In some embodiments, model identifier module 212 can determine that training has not been initiated for an adapter model 184 associated with the user and/or the client account (e.g., upon determining that no adapter model 184 and/or mapping is stored at memory 250 for the user and/or the client account, upon receiving a notification from training module 210 that no adapter model 184 associated with the user and/or the client account is subject to the training phase, etc.). In such embodiments, model identifier module 212 can transmit a signal to training module 210 to initiate a training phase for an adapter model 184 associated with the user and/or the client account, in accordance with embodiments of FIG. 3. In some embodiments, training module 210 and/or model identifier module 212 can transmit a message to client device 102 inquiring whether to initiate the training phase for the adapter model 184. Client device 102 can present the message to the user of client device 102 via a UI. The UI can include one or more UI elements that enable the user to agree or reject initiation of the training phase for the adapter model 184. Training module 210 may initiate the training phase for the adapter model 184 based on a detection of a user interaction with the UI elements. In an illustrative example, the request of block 402 can be received from a client device 102 of a first user (e.g., an individual user) associated with a client account. Training module 210 and/or model identifier module 212 can transmit the message inquiring whether to initiate the training phase to the client device 102 of the first user and/or to another client device of a second user (e.g., an administrator) associated with the client account.

At block 406, processing logic determines whether the adapter model is sufficiently trained. Model identifier module 212 can determine whether the adapter model 184 is sufficiently trained by determining whether one or more training criteria associated with the adapter model 184 are satisfied. Model identifier module 212 can determine that the one or more training criteria are satisfied by determining that an amount of training data provided to train the adapter model 184 exceeds a threshold amount of training data and/or determining that a performance level of the adapter model exceeds a threshold performance level. The threshold amount of training data and/or the threshold performance level can be provided to system 100 by a developer or an operator of system 100 and/or platform 120, in some embodiments. In other or similar embodiments, the threshold amount of training data and/or the threshold performance level can be determined based on historical data, experimental data, testing data, etc. collected for platform 120 and/or system 100.

Responsive to a determination that the adapter model is sufficiently trained, method 400 can proceed to block 408. At block 408, processing logic operationally updates a model pipeline associated with the AI model to include the identified adapter model. As noted above, in some embodiments, training module 210 may remove the trained adapter model 184 from the model pipeline upon completion of the training phase for the adapter model 184. In such embodiments, model pipeline module 214 can update the model pipeline of AI model 182 to include the adapter model 184. For example, model pipeline module 214 can update the model pipeline of AI model 182 to include the adapter model 184 at the layers of AI model 182 associated with the type of electronic document of the request at block 402 and/or the type of task to be performed for the electronic document of the request. Model pipeline module 214 can update the model pipeline to include adapter model 184 in accordance with embodiments described with respect to FIG. 3. In other or similar embodiments, training model 210 may not remove adapter model 184 from the model pipeline upon completion of the training phase and instead may perform one or more operations to deactivate the connection(s) between the adapter model 184 and the layers of AI model 182. In such embodiments, model pipeline module 214 may perform one or more operations to activate the connection(s) between the adapter model 184 and the layers of AI model 182. By activating the connection(s) between the adapter model 184 and the layers of AI model 182, data can be passed between adapter model 184 and AI model 182, as described herein.

FIGS. 5A and 5B depict example model pipelines 500 for a system including an AI model, in accordance with implementations of the present disclosure. As illustrated in FIG. 5A, an adapter model 184A can be included in the model pipeline 500A for AI model 182 such that a prompt can be provided as an input to adapter model 184A and an output of adapter model 184A is provided as an input of AI model 182. In some embodiments, more than one adapter model 184 can be included in the model pipeline for model 182. For example, as illustrated in FIG. 5B, multiple adapter models (e.g., adapter models 184A-184N) can be included in the model pipeline 500B for AI model 184. In some embodiments. Each adapter model 184A-184N can be trained using a training data set collected for a distinct client account, a distinct user, and/or a distinct application of platform 120. In an illustrative example, model pipeline 500B can include a first adapter model 184A associated with a client account of platform 120. The first adapter model 184A can be trained using a training data set associated with the client account and/or users associated with the client account, as described above. Model pipeline 500B can also include a second adapter model 184B associated with a specific user associated with the client account. The second adapter model 184B can be trained using a training data set associated with the specific user (e.g., as opposed to a training data set associated with other users of the client account). Accordingly, the second adapter model 184B can be trained based on the preferred style and/or formatting of the specific user. Upon receiving a request to perform an operation associated with AI model 182 from a client device 102 associated with the specific user, model identifier module 212 can identify the first adapter model 184A and the second adapter model 184B as being associated with the specific user. Model pipeline module 214 can include both the first adapter model 184A and the second adapter model 184B in model pipeline 500B, as illustrated in FIG. 5B.

In some embodiments, additional adapter models 184 can be associated with the electronic document and/or the operation of the request of block 402. For example, a third adapter model 184C can be trained using a training data set associated with electronic documents having a common document type (e.g., e-mail messages, etc.), regardless of the user and/or client account associated with the documents. Model pipeline module 214 can include such adapter model in the model pipeline 500B (e.g., with the first adapter model 184A and the second adapter model 184B), as described above.

In some embodiments, the preferred style and/or format associated with the client account can be different from the preferred style and/or format associated with a specific user. Accordingly, one or more parameter values and/or settings associated with the first adapter model 184A may conflict with one or more parameter values and/or settings associated with the second adapter model 184B. In some embodiments, a user associated with the client account (e.g., an administrator) can provide system 100 with a set of adapter model priority settings, which define which adapter model 184 is to be given priority when a conflict is detected with another adapter model 184. In some embodiments, the adapter model priority settings can be provided by the user associated with the client account via a UI of a client device 102. In other or similar embodiments, the adapter model priority settings can be default settings for the client account (e.g., per the nature of the relationship between the user and the client account. The adapter model priority settings can be stored at memory 250 as client account data 252. Model pipeline module 214 can identify the adapter model priority settings the client account data 252 at memory 250 and, in some embodiments, update one or more bypass settings of the model pipeline 500B in view of the adapter model priority settings. The bypass settings may cause the AI model 182 to bypass or ignore modified parameter values provided by an adapter model 184 associated with a lower priority rating than adapter models 184 of the model pipeline 500B. In an illustrative example, the first adapter model 184A may be associated with a higher priority rating than the second adapter model 184B, per the adapter model priority settings of client account data 252. Accordingly, the bypass settings of model pipeline 500B may cause the AI model 182 to bypass modified parameter values provided by the second adapter model 184B when in conflict with modified parameter values provided by the first adapter model 184A.

Referring back to FIG. 4, at block 410, processing logic provides a prompt including the request to perform the operation as an input to the adapter model. Model pipeline module 214 and/or another component of adapter model manager 152 can provide the prompt 254 as an input to adapter model 184. The prompt 254 can include information of the request of block 402 (e.g., the electronic document or file 121 of the electronic document reference by the request, the type of operation of the request, etc.) and/or additional information associated with the operation of the request, in some embodiments. In some embodiments, the additional information can include contextual data indicating an intent of the request, a reference to an additional file 121 and/or data store that includes information associated with the request, and so forth.

Upon receiving the prompt 254, adapter model 184 can predict values for parameters of AI model 182 to be modified during handling of the prompt, in accordance with the preferred style and/or format for the output of the AI model 182 of the client account and/or the user. The output of the adapter model 184 can include the prompt 254 provided as the input and the predicted values for the modified parameters. The output of the adapter model 184 can be provided as an input to AI model 182. AI model 182 can apply the values for the modified parameters indicated by the output of the adapter model 184 to the layers of the AI model 182 when handling the prompt 254.

At block 412, processing logic obtains one or more outputs of the AI model, where the one or more outputs have the preferred style and/or the preferred format of the client account. As described above, AI model 182 applies the values for the modified parameters, as indicated by the output of the adapter model 184, to the layers of AI model 182 when handling the prompt. By applying the values for the modified parameters, the style and/or format of the output of the AI model matches (or approximately matches) the preferred style and/or format associated with the client account and/or the user (e.g., as defined in the electronic documents of the training data set for the adapter model 184).

At block 414, processing logic provides a response to the request that is performed using the obtained output of the AI model. As described above, the operation of the request can include a content generation operation, a content augmentation operation, a content summarization operation, a content expansion operation, a content classification operation, a knowledge retrieval operation, a data conversion operation, a program task operation, and so forth. In some embodiments, an output of the operation can include, but is not limited to, additional content generated based on content of the electronic document of the request of block 402 (e.g., the additional content including new content and/or augmented content), a summarization of the content, an expanded version of the content, a classification of one or more portions of the content, answer data in view of one or more knowledge inquiries associated with the content, an output of a program task performed based on the content and/or characteristics of the content, and so forth. As described above, the response to the request can have the preferred style and/or format of the client account and/or the user.

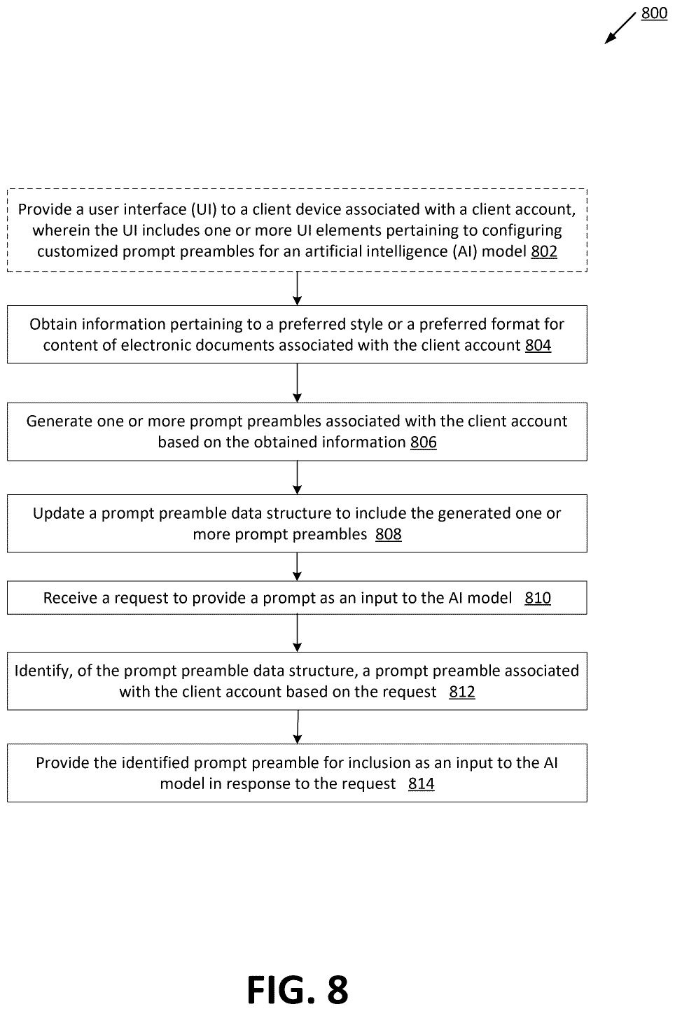

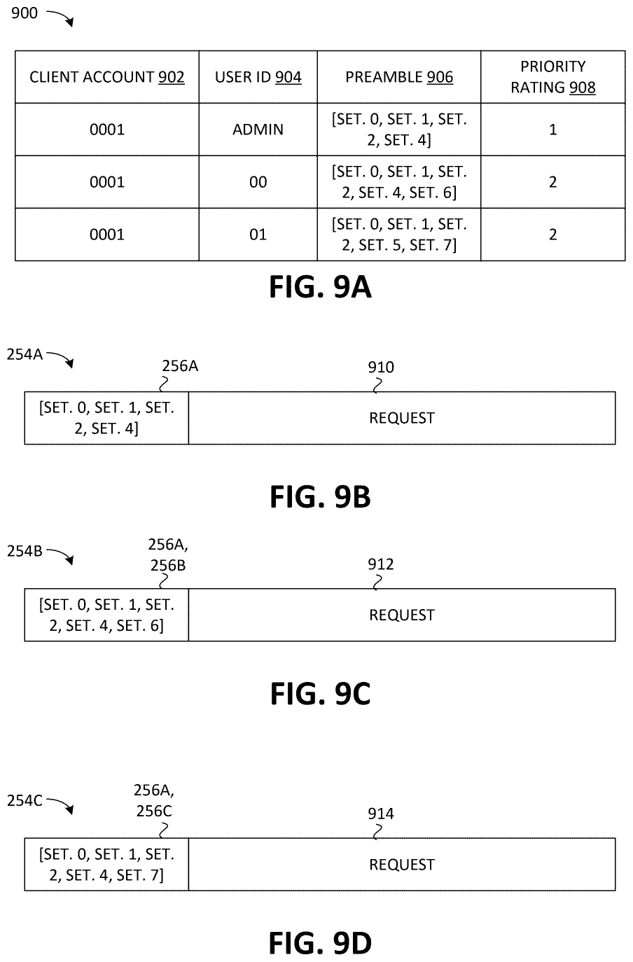

Referring back to block 406, responsive to a determination that the adapter model is not sufficiently trained, method 400 can proceed to block 416. At block 416, processing logic identifies one or more prompt preambles associated with the preferred style and/or the preferred format of the client account. A prompt preamble refers to data or information that indicates a preferred style or format of an output of AI model 182 defined for a client account of platform 120. In some embodiments, a prompt preamble can be provided by a user associated with the client account (e.g., an administrator) and stored at memory 250 as a prompt preamble 254. In other or similar embodiments, the prompt preamble can be generated or otherwise obtained by a preamble generated module 220 of prompt preamble manger 162. Further details regarding obtaining a prompt preamble are provided with respect to FIGS. 8-9D below. Preamble identifier module 222 of prompt preamble manager 162 can identify the prompt preamble 256 for the client account from memory 250, in some embodiments.

At block 418, processing logic provides a prompt including the one or more prompt preambles and the request to perform the operation as an input to the AI model. Prompt preamble manager 162 can provide the prompt 254 including the identified prompt preamble 256 and the request to perform the operation directly to AI model 182. Upon proving the prompt as an input to the AI model 182, method 400 can continue to block 412. As noted above, at block 412, processing logic obtains one or more outputs of the AI model. The one or more outputs have the preferred style and/or the preferred format of the client account (e.g., as defined by prompt preamble 256). At block 414, processing logic provides a response to the request that is performed using the obtained output of the AI model, in accordance with previously described embodiments.

It should be noted that although FIG. 4 depicts operations relating to the use of adapter models 184 and prompt preambles 256, embodiments of the present disclosure can be performed with respect to the user of adapter models (e.g., without the use of prompt preambles 256) and/or with the user of prompt preambles 256 (e.g., without the user of adapter models 184). Reference to both adapter models 184 and prompt preambles 256 with respect to FIG. 4 (and elsewhere in the description) is provided for the purpose of example and explanation only and is not intended to be limiting.

It should also be noted that although embodiments of the present disclosure refer to training an adapter model 184 based on a training data set including electronic documents having a preferred style or format of a client account and/or a user, embodiments of the present disclosure can be applied to any type of adapter model that is trained using any type of training data set.

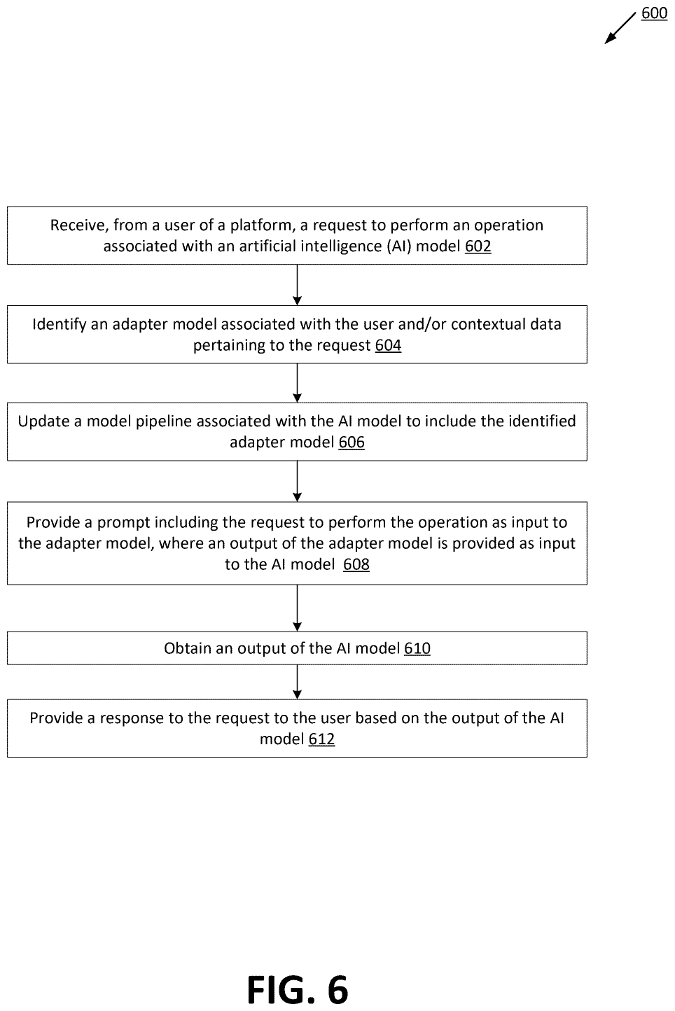

FIG. 6 depicts a flow diagram of another example method 600 for obtaining a response to a query using artificial intelligence (AI), in accordance with implementations of the present disclosure. Method 600 can be performed by processing logic that can include hardware (circuitry, dedicated logic, etc.), software (e.g., instructions run on a processing device), or a combination thereof. In one implementation, some or all the operations of method 600 can be performed by one or more components of system 100 of FIG. 1. In some embodiments, some or all of the operations of method 600 can be performed by adapter model manager 152 and/or predictive system 180. For example, some or all of operations of method 600 can be performed by model identifier module 212 and/or model pipeline module 214 of adapter model manager 152.

At block 602, processing logic receives, from a user of a platform, a request to perform an operation associated with an AI model. Platform 120 can receive requests from a client device 102 to perform the operation associated with the AI model 182. In some embodiments, the AI model 182 can be trained to perform tasks associated with files 121 for electronic documents of platform 120. In other or similar embodiments, the trained AI model 182 can be trained to perform additional or alternative tasks. In some embodiments, AI model 182 can include a LLM, as described herein. Platform 120 can receive the request from client device 102 responsive to a user interaction with a UI of client device 102, as described herein.

At block 604, processing logic identifies an adapter model associated with the user and/or contextual data pertaining to the request. In some embodiments, model identifier module 212 can determine an identifier associated with client device 102 and/or a user of client device 102 and can determine whether memory 250 stores an adapter model 184 and/or a mapping for an adapter model 184 associated with the determined identifier. Upon determining that memory 250 stores the adapter model 184 and/or the mapping for the adapter model 184, model pipeline module 214 can retrieve the adapter model 184 (e.g., from memory 250 or from another memory identified by the mapping). In some embodiments, model identifier module 212 can determine that the adapter model 184 is already included in a model pipeline for the AI model 182, in accordance with previously described embodiments. In yet other or similar embodiments, model identifier module 212 can determine that no adapter model associated with the user and/or the client device 102 has been trained or is in the training phase. Accordingly, model identifier module 212 can transmit a signal to training module 210 to initiate the training process, as described above.

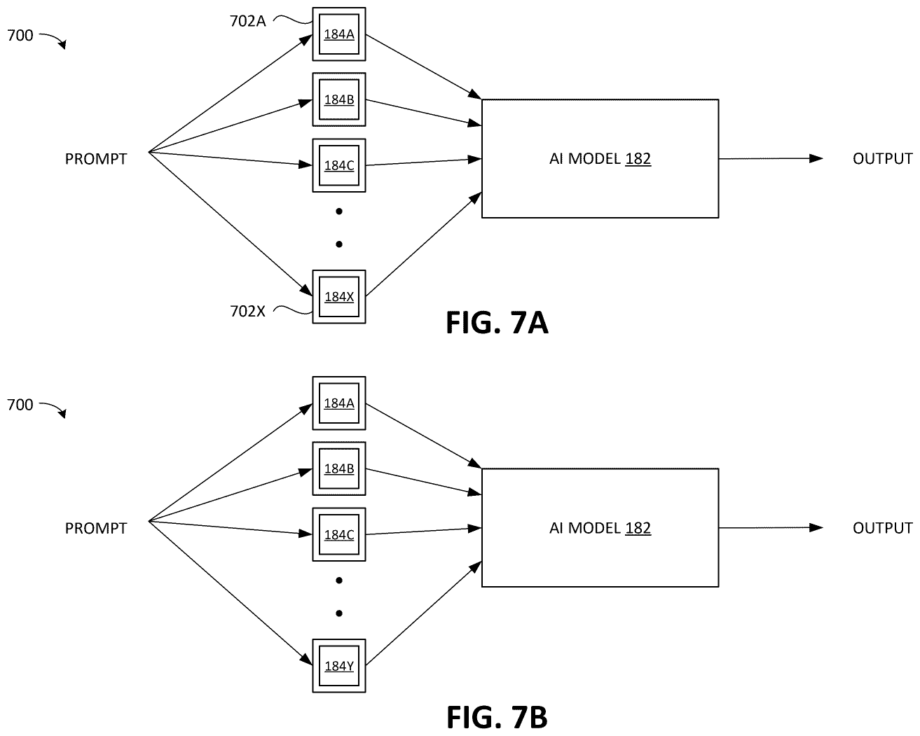

At block 606, processing logic updates a model pipeline associated with the AI model to include the identified adapter model. Model pipeline module 214 can update the model pipeline associated with AI model 182 to include the identified adapter model 184 in accordance with embodiments described herein. FIGS. 7A and 7B depict other example model pipelines 700 for a system including an AI model, in accordance with implementations of the present disclosure. In some embodiments, a model architecture can include a finite number of adapter model slots 702 that can connect an adapter model 184 to layers of AI model 182. The finite number of slots may be defined by a developer or engineer of AI model 182 (e.g., to reduce the overall size of the AI model 182). A slot refers to a specific position or component within a model's structure where operations, transformations, or additional layers can be applied. In some embodiments, an adapter model slot 702 can include a multi-head self-attention slot, that includes a multi-head self-attention mechanism followed by a feed-forward neural network.

In some embodiments, model pipeline module 214 can determine whether model pipeline 700 includes any slots 702 that are available for the adapter model 184 associated with the request of block 602. A slot 702 is available for an adapter model 184 if no other adapter models 184 are currently occupying the slot 702. In an illustrative example, the identified adapter model of block 604 can be adapter model 184X. Model pipeline module 214 can determine that slot 702X is available and therefore can update the model architecture of AI model 182 to include adapter model 184X at slot 702X.

Referring back to FIG. 6, at block 608, processing logic provides a prompt including the request to perform the operation as an input to the adapter model, where an output of the adapter model is provided as an input to the AI model. Processing logic can provide the prompt as the input to the adapter model 184 in accordance with previously described embodiments. At block 610, processing logic obtains an output of the AI model. Processing logic can obtain the output of the AI model in accordance with previously described embodiments. At block 612 can provide a response to the request based on the output of the AI model. Processing logic can provide a response to the request in accordance with previously described embodiments.

In some embodiments, processing logic can receive an additional request from an additional user of platform 120 to perform another operation associated with AI model 182. Model identifier module 212 can identify an adapter model 184 associated with the additional user and/or the contextual data pertaining to the request, as described above, and can determine whether model pipeline 700 has a slot that is available to connect the identified adapter model 184 in the model architecture. As illustrated by FIG. 7A, model pipeline 700 does not have any available slots for the adapter model 184 associated with the additional user of platform 120 (e.g., adapter model 184Y). In such embodiments, model pipeline module 214 can identify an adapter model included in a slot of 702 for removal and can replace the identified adapter model 184 with adapter model 184Y. Model pipeline module 214 may identify the adapter model 184 for removal from the slot 702 according to an adapter model removal policy of AI model 182, platform 120, and/or system 100. The adapter model removal policy can be defined by a developer or engineer of AI model 182, platform 120, system 100, and so forth, and include a policy such as a not recently used policy (e.g., where an adapter model 184 that has not been used in a threshold amount of time is selected for removal), a first-in, first-out policy (e.g., where an adapter model 184 that has been included at a slot longer than other adapter models 184 is selected for removal), a least recently used policy (e.g., where the adapter model 184 that has been least recently used is selected for removal), not frequently used policy (e.g., where an adapter module 184 that has been used with the lowest degree of frequency is selected for removal), and so forth. As illustrated in FIG. 7B, adapter model 184X may be selected for removal from the model pipeline 700 (e.g., per the adapter model removal policy). Upon removal of adapter model 184X from slot 702X, model pipeline model 214 can update the model architecture of AI model 182 to include adapter model 184Y at slot 702X.

Although some embodiments of the present disclosure provide that system 100 include a trained adapter model 184 in a pipeline of a model architecture for AI model 182 to obtain a customized response for a user query, in additional or alternative embodiments, system 100 can obtain the customized response according to other techniques. For example, system 100 can obtain the customized response by providing a prompt as a direct input to AI model 182 with a prompt preamble including information that indicates a preferred style or format for the output of the AI model 182, as described below with respect to FIGS. 8-9D.

FIG. 8 depicts a flow diagram of another example method 800 for obtaining a response to a query using artificial intelligence (AI), in accordance with implementations of the present disclosure. Method 800 can be performed by processing logic that can include hardware (circuitry, dedicated logic, etc.), software (e.g., instructions run on a processing device), or a combination thereof. In one implementation, some or all the operations of method 800 can be performed by one or more components of system 100 of FIG. 1. In some embodiments, some or all of the operations of method 600 can be performed by prompt preamble manager 152 and/or predictive system 180.

At block 802, processing logic optionally provides a UI to a client device associated with a client account. The UI can include one or more UI elements pertaining to configuring customized prompt preambles for an AI model. In some embodiments, preamble generator module 220 can provide the UI to a client device 102 associated with an administrator of the client account. The UI elements, in some embodiments, can include a text box or other such element type that enables the user to provide the prompt preambles for the AI model 182. In other or similar embodiments, the UI elements can include buttons or other such element types that enable the user to select from different types of prompt preambles by engagement with the buttons. In other or similar embodiments, the UI elements can include buttons or other such element types that enable the users to select style and/or formatting elements for content of the electronic documents. In some embodiments, the UI can include a form-structure that includes a series of questions or prompts for the user.

At block 804, processing logic obtains information pertaining to a preferred style or a preferred format for content of electronic documents associated with the client account. In some embodiments, preamble generator module 220 can obtain the information based on a user input via the UI provided in accordance with block 802. In other or similar embodiments, preamble generator module 220 can identify files 121 for one or more electronic documents associated with the client account and can extract the preferred style or the preferred format from content of the electronic documents. In some embodiments, the user associated with the client account can provide the electronic documents. In other or similar embodiments, preamble generator module 220 can identify the files 121 for the electronic documents from memory 250 and/or data store 110 (e.g., based on an identifier associated with the client account). In some embodiments, preamble generator module 220 can extract the preferred style or the preferred format based on one or more style or format rules defined by a developer or engineer of the platform 120 and/or the system 100. In other or similar embodiments, preamble generator module 220 can provide the files 121 and/or content of the electronic documents as an input to a content style/format model that is trained to predict features indicating a preferred style or format of content based on given content. Preamble generator module 220 can extract the preferred style or format associated with the client account from one or more outputs of the content style/format model, in some embodiments.

At block 806, processing logic generates one or more prompt preambles associated with the client account based on the obtained information. In some embodiments, preamble generator module 220 can generate or otherwise obtain information indicating the preferred style or the preferred formation for the content of the electronic documents. The information can include a natural language description of the preferred style (e.g., content tone, such as formal, informal, persuasive, etc.) and/or format (e.g., outline format, paragraph format, etc.) for the content, in some embodiments. In other or similar embodiments, the information can include one or more feature vectors that indicate the preferred style and/or format of the content. The prompt preamble 256 can include the information generated and/or obtained by the preamble generator module 220. In some embodiments, the prompt preamble 256 can reference one or more AI model settings that are to be applied by the AI model 182 when handing a prompt, in view of the obtained information.

At block 808, processing logic updates a prompt preamble data structure to include the generated one or more prompt preambles. FIG. 9A illustrates an example prompt preamble data structure 900, in accordance with embodiments of the present disclosure. As illustrated by FIG. 9A, entries of the preamble data structure 900 can include one or more fields, such as a client account identifier field 902, a user identifier field 904, a preamble field 906, and/or a priority rating field 908. In some embodiments, each entry of data structure 900 is associated with a respective user associated with the client account. It should be noted that entries of data structure 900 can include additional or alternative fields and can be organized according to different techniques. Upon generating the prompt preamble(s) 256, preamble generator module 220 can update the data structure 900 to include one or more entries for the associated client account.

In some embodiments, prompt preamble generator 220 can generate the prompt preamble 256 for a respective client account, as described above. Prompt preamble generator 220 can additionally or alternatively generate a prompt preamble 256 that is distinct for respective users associated with the client account (e.g., based on preferred style or format determined for the respective users). As illustrated in FIG. 9A, data structure 900 can also include entries for users of the client account that include distinct prompt preambles determined for the respective users.

As illustrated by FIG. 9A, entries of data structure 900 can include a priority rating field 908. Values of the priority rating field 908 indicate a priority rating given to the corresponding prompt preamble 256 relative to other prompt preambles associated with the client account 902. The prompt preamble rating can be provided or defined by an administrator user of the client account in some embodiments. For example, an administrator user of the client account can provide (e.g., via a UI of client device 102) that the prompt preamble obtained for the administrator user is to have a higher priority than prompt preambles obtained for individual suers associated with the client account.

At block 810, processing logic receives a request to provide a prompt as an input to the AI model. Platform 120 can receive a request from a client device 102 to perform an operation associated with AI model 182, as described above. The request received from the client device 102 can include and/or correspond to a request to provide a prompt as an input to the AI model. At block 812, processing logic identifies, of the prompt preamble data structure, a prompt preamble associated with the client account based on the request. In some embodiments, preamble identifier module 222 will determine an client account identifier (ID) and/or a user ID associated with the request. The client account ID and/or the user ID can be included in the request received from the client device 102, in some embodiments. For example, the request can include a user ID associated with the client device 102 that provided the request. Preamble identifier module 222 can determine the client ID associated with the request based on the user ID (e.g., by referencing an additional data structure that includes a mapping between client IDs and user IDs). Preamble identification module 222 can determine one or more entries of data structure 900 associated with the determined client ID and/or the user ID.

In some embodiments, preamble identifier module 222 can determine the user ID associated with the request, as described above, and can identify one or more entries of data structure 900 that correspond to the determined user ID. Upon identifying the one or more entries, preamble identifier module 222 can determine a client ID associated with the user ID based on the client account field 902 of the identified entries.

At block 814, processing logic provides the identified prompt preamble for inclusion as an input to the AI model in response to the request. In some embodiments, preamble identifier module 222 can identify an entry of data structure 900 that corresponds to the request and can extract the prompt preamble 956 from the prompt preamble field 906 of the identified entry. Preamble identifier module 222 (or another component of prompt preamble manager 162) can generate a prompt 254 for the AI model 184 that includes the request received by platform 120 (or the operation of the request received by platform 12) and the prompt preamble extracted from the entry. FIGS. 9B-9D illustrate example AI model prompts 254 generated based on a prompt preamble 256 and a request received by platform 120. In accordance with previously described embodiments, platform 120 can receive the request 910 from client device 102 associated with a user of the client account having an ID of “ADMIN” (e.g., an administrator user). Therefore, the generated prompt 254A can include the prompt preamble 256A extracted from the corresponding entry of data structure 900 and information of the request 910.

In some embodiments, platform 120 may receive a request that is associated with two or more entries of data structure 900. For example, platform 120 may receive a request 912 from a user having a user ID of “00.” Preamble identifier module 222 can identify an entry of data structure 900 that is associated with the request 912 based on the user ID of the request and can determine that the user is associated with a client account having a client account ID of “0001.” Preamble identifier module 222 can parse data structure 900 to identify other entries associated with the client account ID of “0001.” In some embodiments, preamble identifier module 222 can identify entries of data structure 900 that are associated with the common client account ID and have a higher priority rating than the priority rating for the entry of the request. In an illustrative example, upon identifying the entry of data structure 900 that is associated with the request 912, preamble identifier module 222 can identify multiple other entries associated with client account ID “0001.” Preamble identifier module 222 can determine that another entry having a user ID of “ADMIN” has a higher priority rating than the priority rating for the entry of request 912. As the priority rating for the entry including the user ID of “ADMIN” is higher than the priority rating for the entry of the request 912, preamble identifier module 222 can determine the prompt 254B for the request 912 is to include the prompt preambles 256 from both entries. As illustrated in FIG. 9C, the prompt 254B can include the prompt preambles 256A and 256B from the identified entries and the request 912, in accordance with previously described embodiments.

In an illustrative example, prompt preambles 256A and prompt 256B include some common settings and some different settings. For instance, prompt preamble 256A includes settings “SET. 0, SET. 1, SET. 2, and SET. 4” and prompt preamble 256A includes settings “SET. 0, SET. 1, SET. 2, SET. 4, and SET. 6.” As the settings of prompt preamble 256B does not conflict with the settings of prompt preamble 256A, prompt 254B includes the settings of both prompt preamble 256A and prompt preamble 256B. In some embodiments, prompt preambles 256 can have conflicting settings. For example, prompt preamble 256A includes settings “SET. 0, SET. 1, SET. 2, and SET. 4” and prompt preamble 256C includes settings “SET. 0, SET. 1, SET. 2, SET. 5, and SET. 7” (e.g., as indicated by the entry for user ID “01” of data structure 900). As “SET. 5” of preamble 256C conflicts with “SET 4” of preamble 256A, prompt 254C will include “SET. 4” and will not include “SET. 5,” per the priority ratings of data structure 900, as illustrated in FIG. 9D.

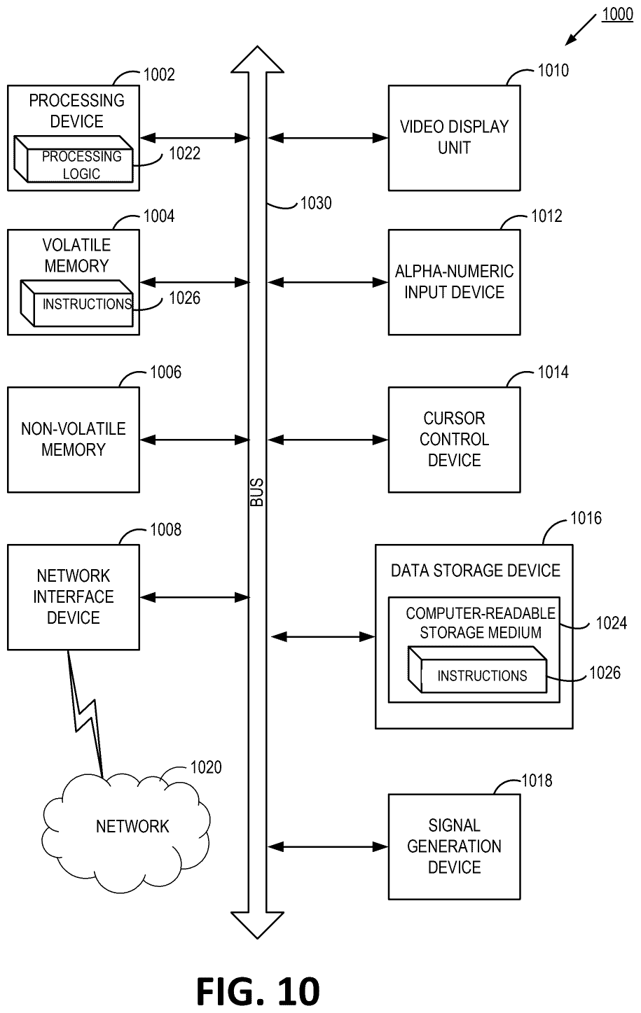

FIG. 10 is a block diagram illustrating an exemplary computer system 1000, in accordance with implementations of the present disclosure. The computer system 1000 can correspond to platform 120, client devices 102A-N, server machine 150, server machine 160, and/or predictive system 180 described herein and with respect to FIGS. 1-9D. Computer system 1000 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processing device (processor) 1002, a main memory 1004 (e.g., read-only memory (ROM), flash memory, dynamic random access memory (DRAM) such as synchronous DRAM (SDRAM), double data rate (DDR SDRAM), or DRAM (RDRAM), etc.), a static memory 1006 (e.g., flash memory, static random access memory (SRAM), etc.), and a data storage device 1018, which communicate with each other via a bus 1040.

Processor (processing device) 1002 represents one or more general-purpose processing devices such as a microprocessor, central processing unit, or the like. More particularly, the processor 1002 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1002 can also be one or more special-purpose processing devices such as an application specific integrated circuit (ASIC), a field programmable gate array (FPGA), a digital signal processor (DSP), network processor, or the like. The processor 1002 is configured to execute instructions 1005 for performing the operations discussed herein.

The computer system 1000 can further include a network interface device 1008. The computer system 1000 also can include a video display unit 1010 (e.g., a liquid crystal display (LCD) or a cathode ray tube (CRT)), an input device 1012 (e.g., a keyboard, and alphanumeric keyboard, a motion sensing input device, touch screen), a cursor control device 1014 (e.g., a mouse), and a signal generation device 1020 (e.g., a speaker).

The data storage device 1018 can include a non-transitory machine-readable storage medium 1024 (also computer-readable storage medium) on which is stored one or more sets of instructions 1005 embodying any one or more of the methodologies or functions described herein. The instructions can also reside, completely or at least partially, within the main memory 1004 and/or within the processor 1002 during execution thereof by the computer system 1000, the main memory 1004 and the processor 1002 also constituting machine-readable storage media. The instructions can further be transmitted or received over a network 1030 via the network interface device 1008.

In one implementation, the instructions 1005 include instructions for providing fine-grained version histories of electronic documents at a platform. While the computer-readable storage medium 1024 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving, from a client device of a user associated with a client account, a request to perform an operation associated with an artificial intelligence (AI) model;
identifying an adapter model associated with the client account, wherein the adapter model is trained to modify one or more parameters of the AI model based on one or more electronic documents associated with the client account, the one or more electronic documents having a preferred style or a preferred format of the client account;
providing a prompt comprising the request to perform the operation as an input to the adapter model, wherein an output of the adapter model is used by the AI model;
obtaining an output of the AI model, wherein the obtained output has at least one of the preferred style or the preferred format of the client account; and
providing a response to the request that is performed using the obtained output of the AI model.

2. The method of claim 1, further comprising:
prior to providing the prompt comprising the request to perform the operation as an input to the adapter model, determining whether one or more training criteria associated with the adapter model are satisfied, wherein the prompt is provided as the input to the model responsive to determining that the one or more training criteria associated with the adapter model is satisfied.

3. The method of claim 2, further comprising:
responsive to determining that the one or more training criteria associated with the adapter model are not satisfied, identifying one or more prompt preambles associated with the client account, wherein the one or more prompt preambles indicate the preferred style or the preferred format of the client account;
providing the prompt and the one or more prompt preambles as an input to the AI model;
obtaining an output of the AI model based on the provided prompt and the one or more prompt preambles; and
providing the response to the request that is performed using the obtained output of the AI model.

4. The method of claim 3, further comprising:
receiving the one or more prompt preambles from at least one of the client device of the user or another client device of another user associated with the client account, or
generating the one or more prompt preambles based on one or more prior electronic documents associated with the client account.

5. The method of claim 2, wherein determining whether the one or more training criteria associated with the adapter model are satisfied comprises at least one of:
determining whether an amount of training data provided to train the adapter model exceeds a threshold amount of training data, or
determining whether a performance level of the adapter model exceeds a threshold performance level.

6. The method of claim 1, further comprising:
responsive to identifying the adapter model, updating a model pipeline associated with the AI model to include the adapter model at an input of one or more model layers of the AI model associated with the operation of the request.

7. The method of claim 6, further comprising:
identifying an additional adapter model associated with the user associated with the client account, wherein the additional adapter model is trained to modify one or more parameters of the AI model based on at least one of a preferred style, a preferred format, or a preferred data source of the user;
updating the model pipeline associated with the AI model to include the additional adapter model at an output of the adapter model and at the input of the one or more model layers of the AI model associated with the operation of the request.

8. The method of claim 7, further comprising:
determining one or more adapter model priority settings associated with each of the adapter model and the additional adapter model; and
updating one or more bypass settings associated with the model pipeline based on the determined one or more adapter model priority settings, wherein, upon detection of a conflict between the preferred style or the preferred format of the user and the preferred style or the preferred format of the client account, at least one of the adapter model or the additional adapter model is bypassed in the model pipeline in accordance with the determined one or more adapter model priority settings.

9. The method of claim 1, wherein the adapter model is further trained to modify the one or more parameters of the AI model based on one or more preferred data sources of the client account.

10. The method of claim 1, wherein the operation of the request comprises at least one of:
a content generation operation;
a content augmentation operation;
a content summarization operation;
a content expansion operation;
a content classification operation;
a knowledge retrieval operation;
a data conversion operation; or
a program task operation.

11. The method of claim 1, wherein the adapter model is trained by:
obtaining a set of electronic documents associated with the client account;
identifying, of the AI model, one or more layers pertaining to at least one of the set of electronic documents or operations associated with the set of electronic documents;
updating a model pipeline associated with the AI model to include the adapter model at a region of an architecture for the AI model that is associated with the identified one or more layers;
obtaining a training data set comprising training data generated based on the at least one of the set of electronic documents or the operations associated with the set of electronic documents; and
providing the generated training data set as an input to the AI model to train the adapter model.

12. The method of claim 11, wherein obtaining the training data set comprises:
extracting, from the set of electronic documents, at least one of content of the set of electronic documents or characteristic data indicating one or more characteristics of the content;
obtaining an output of at least one operation associated with the set of electronic documents, wherein the output of the at least one operation comprises one or more of:
additional content generated based on the at least one of the content or the one or more characteristics of the content, wherein the additional content comprises at least one of new content or augmented content,
a summarization of the content according to at least one of a style or a format indicated by the one or more characteristics of the content,
an expanded version of the content according to at least one of the style or the format indicated by the one or more characteristics of the content,
a classification of one or more portions of the content based on at least one of the style or the format indicated by the one or more characteristics of the content,
answer data in view of one or more knowledge inquiries associated with the content, or
an outcome of a program task performed based on the at least one of the content or the one or more characteristics of the content;
generating an input-output mapping, wherein an input of the input-out mapping comprises the at least one of the content or the characteristic data extracted from the set of electronic documents, and wherein an output of the input-output mapping comprises the output of the at least one operation associated with the set of electronic documents; and
updating the training data set to include the generated input-output mapping.

13. The method of claim 1, wherein the adapter model comprises at least one of a bottleneck adapter model, an invertible adapter model, a compacter adapter model, a prefix tuning adapter model, a low-rank adaptation (LoRA) model, an infused adapter model, a mix-and-match adapter model, a universal parameter-efficient language model tuning (PELT) adapter model, or a prompt tuning model.

14. A system comprising:
a memory; and
a set of one or more processing devices coupled to the memory, wherein the set of one or more processing devices is to perform operations comprising:
receiving, from a client device of a user associated with a client account, a request to perform an operation associated with an artificial intelligence (AI) model;
identifying an adapter model associated with the client account, wherein the adapter model is trained to modify one or more parameters of the AI model based on one or more electronic documents associated with the client account, the one or more electronic documents having a preferred style or a preferred format of the client account;
providing a prompt comprising the request to perform the operation as an input to the adapter model, wherein an output of the adapter model is used by the AI model;
obtaining an output of the AI model, wherein the obtained output has at least one of the preferred style or the preferred format of the client account; and
providing a response to the request that is performed using the obtained output of the AI model.

15. The system of claim 14, wherein the operations further comprise:
prior to providing the prompt comprising the request to perform the operation as an input to the adapter model, determining whether one or more training criteria associated with the adapter model are satisfied, wherein the prompt is provided as the input to the model responsive to determining that the one or more training criteria associated with the adapter model is satisfied.

16. The system of claim 15, wherein the operations further comprise:
responsive to determining that the one or more training criteria associated with the adapter model are not satisfied, identifying one or more prompt preambles associated with the client account, wherein the one or more prompt preambles indicate the preferred style or the preferred format of the client account;
providing the prompt and the one or more prompt preambles as an input to the AI model;
obtaining an output of the AI model based on the provided prompt and the one or more prompt preambles; and
providing the response to the request that is performed using the obtained output of the AI model.

17. The system of claim 16, wherein the operations further comprise:
receiving the one or more prompt preambles from at least one of the client device of the user or another client device of another user associated with the client account, or
generating the one or more prompt preambles based on one or more prior electronic documents associated with the client account.

18. The system of claim 15, wherein determining whether the one or more training criteria associated with the adapter model are satisfied comprises at least one of:
determining whether an amount of training data provided to train the adapter model exceeds a threshold amount of training data, or
determining whether a performance level of the adapter model exceeds a threshold performance level.

19. The system of claim 14, wherein the operations further comprise:
responsive to identifying the adapter model, updating a model pipeline associated with the AI model to include the adapter model at an input of one or more model layers of the AI model associated with the operation of the request.

20. A non-transitory computer readable storage medium comprising instructions that, when executed by a processing device, cause the processing device to perform operations comprising:
receiving, from a client device of a user associated with a client account, a request to perform an operation associated with an artificial intelligence (AI) model;
identifying an adapter model associated with the client account, wherein the adapter model is trained to modify one or more parameters of the AI model based on one or more electronic documents associated with the client account, the one or more electronic documents having a preferred style or a preferred format of the client account;
providing a prompt comprising the request to perform the operation as an input to the adapter model, wherein an output of the adapter model is used by the AI model;
obtaining an output of the AI model, wherein the obtained output has at least one of the preferred style or the preferred format of the client account; and
providing a response to the request that is performed using the obtained output of the AI model.
